(19) United States
(12) Patent Application Publication
(10) Pub. No.: US 2015/0228097 A1
(43) Pub. Date: Aug. 13, 2015

(54) Systems and Methods for Axis Table Plot Display

(71) Applicant: SAS Institute Inc., Cary, NC (US)

(72) Inventors: Sanjay Matange, Cary, NC (US); Pratik Phadke, Cary, NC (US); Xiao Le Xu, Cary, NC (US); Lingxiao Li, Cary, NC (US); Dan Heath, Cary, NC (US); Prashant Hebbar, Cary, NC (US)

(21) Appl. No.: 14/620,050

(22) Filed: Feb. 11, 2015

Related U.S. Application Data
(60) Provisional application No. 61/938,686, filed on Feb. 11, 2014.

(51) Int. Cl. G06T 11/20; G06T 11/60

(52) U.S. Cl. CPC G06T 11/206; G06T 11/60

(57) ABSTRACT

A graph display that includes a data plot and at least one data table is generated in response to a received graphing request to generate a graph display, wherein the graphing request specifies at least one pairing of an axis name and a table column name. The data plot of the generated graph display includes plot points located relative to a horizontal axis of the data plot identified by a horizontal axis name and located relative to a vertical axis of the data plot identified by a vertical axis name and textual representation of the data table aligned with the horizontal or vertical axis, and either the horizontal axis name or the vertical axis name corresponds to the axis name of the at least one pairing in the graphing request.

### CROSS-REFERENCE TO RELATED APPLICATIONS

The present disclosure claims priority to U.S. Provisional Application No. 61/938,686 filed Feb. 11, 2014 and titled “Axis Table Plot”, the entirety of which is incorporated herein by reference.

### TECHNICAL FIELD

The present disclosure generally relates to computer-implemented systems and methods for generating and displaying data graphs with tables of data that are automatically aligned with one or more graph axes.

### BACKGROUND

Graphs are used to display data and assist in data analysis in many fields, for example, statistical analysis of data sets. It is often useful to display information about the data sets in text that is adjacent to a data plot. The information may be displayed in a data table format, wherein data or statistical information is aligned with the X-axis or Y-axis of the graph. The display is a combination of the graphical representation of the data along with textual information that is placed at the desired location, aligned with values on the X axis or Y axis. Such a display helps to provide a better understanding of the data.

### SUMMARY

In accordance with the teachings provided herein, systems and methods for generating data graphs with tables of data that are automatically aligned with a graph axis are provided.

The disclosure provides a computer-program product, tangibly embodied in a non-transitory machine-readable storage medium, including instructions configured to be executed to cause a data processing apparatus of a graphing computer system to perform a method comprising:
receiving a graphing request to generate a graph display, wherein the graphing request specifies at least one pairing of an axis name and a table column column name, wherein the generated graph display includes a data plot and at least one data table, and the data plot of the generated graph display includes plot points located relative to a horizontal axis of the data plot identified by a horizontal axis name and located relative to a vertical axis of the data plot identified by a vertical axis name, and wherein either the horizontal axis name or the vertical axis name corresponds to the axis name of the at least one pairing in the graphing request;
generating a graph template of the graph display, in accordance with the received graphing request, such that the generated graph template specifies the data plot and the at least one data table; and
providing the graph template to a rendering engine of the graphing computer system, such that the rendering engine generates the graph display and produces the data plot such that the produced data plot includes plot points located relative to the horizontal axis of the data plot identified by the horizontal axis name and relative to the vertical axis of the data plot identified by the vertical axis name.

The disclosure further provides a computer-program product, wherein the generated graph display includes at least one data table in the graph display, the generated data table comprising text data values from the dataset, and further comprising the data plot and the at least one data table, such that the text data values of the at least one data table are aligned with either the horizontal axis or the vertical axis of the data plot name.

The disclosure further provides a computer-program product, wherein the graphing request specifies more than one data table and, for each specified data table of the graph display, the graphing request includes the horizontal axis name or the vertical axis name with which the data table will be aligned and includes a table column name that identifies an additional subset of the dataset from which the text data values are obtained, such that the text data values are placed in the data table and correspond to plot points of the data plot, with which the data table values are aligned.

The disclosure further provides a computer-program product, wherein the at least one data table comprises part of every cell of a lattice table of the plot, such that the lattice table includes multiple data rows or data columns or both.

The disclosure further provides a computer-program product, wherein the graphing request includes a plurality of axis name and table column name pairs.

The disclosure further provides a computer-program product, wherein the graphing request includes both a horizontal axis name and a vertical axis name.

The disclosure further provides a computer-program product, wherein the data plot includes a secondary horizontal axis opposite the named horizontal axis.

The disclosure further provides a computer-program product, wherein the graphing request specifies a data table aligned with the secondary horizontal axis.

The disclosure further provides a computer-program product, wherein the data plot includes a secondary vertical axis opposite the named vertical axis.

The disclosure further provides a computer-program product, wherein the graphing request specifies a data table aligned with the secondary vertical axis.

The disclosure further provides a computer-program product, wherein generating the graph display comprises computing the configuration of the data table such that rows and columns of the data table are arranged in the graph display according to placement specified in the graphing request.

The disclosure further provides a computer-program product, wherein the graph display includes multiple data tables arranged in alignment with an axis of the data plot.

The disclosure further provides a computer-program product, wherein the graphing request includes preference weights and generating the graph template comprises arranging the rows and columns of the data table according to the preference weights. The preference weights are defined as the weight that exactly fits the textual contents of the data table to the plot.

The disclosure further provides a computer-program product, wherein the graphing request includes text options that specify text operations on the text data values of the data table.

The disclosure further provides a computer-program product, wherein the specified text operations affect a type font color of the text data values.

The disclosure further provides a computer-program product, wherein the specified text operations affect a type size of the text data values. The current implementation does not affect the type size. It may affect the font weight (e.g., bold or non-bold) and font style (e.g., italic or normal).

The disclosure further provides a computer-program product, wherein the specified text operations affect a type alignment of the text data values.

The disclosure further provides a computer-program product, wherein attributes for the text data values can be received from a Discrete Attributes Map of the graphing computer system.

The disclosure further provides a computer-program product, wherein the graphing request specifies one or more statistical processing options that are applied to the text data values.

The disclosure also provides a graphing computer system, the graphing computer system comprising:
a processor; and
a non-transitory computer-readable storage medium that includes instructions that are configured to be executed by the processor such that, when executed, the instructions cause the graphing computer system to perform operations including:
   receiving a graphing request to generate a graph display, wherein the graphing request specifies at least one pairing of an axis name and a table column name, wherein the generated graph display includes a data plot and at least one data table, and the data plot of the generated graph display includes plot points located relative to a horizontal axis of the data plot identified by a horizontal axis name and located relative to a vertical axis of the data plot identified by a vertical axis name, and wherein either the horizontal axis name or the vertical axis name corresponds to the axis name of the at least one pairing in the graphing request;
   generating a graph template of the graph display, in accordance with the received graphing request, such that the generated graph template specifies the data plot and the at least one data table; and
   providing the graph template to a rendering engine of the graphing computer system, such that the rendering engine generates the graph display and produces the data plot such that the produced data plot includes plot points located relative to the horizontal axis of the data plot identified by the horizontal axis name and relative to the vertical axis of the data plot identified by the vertical axis name.

The disclosure also provides a method of operating a graphing computer system, the method comprising:
receiving a graphing request to generate a graph display, wherein the graphing request specifies at least one pairing of an axis name and a table column name, wherein the generated graph display includes a data plot and at least one data table, and the data plot of the generated graph display includes plot points located relative to a horizontal axis of the data plot identified by a horizontal axis name and located relative to a vertical axis of the data plot identified by a vertical axis name, and wherein either the horizontal axis name or the vertical axis name corresponds to the axis name of the at least one pairing in the graphing request;
generating a graph template of the graph display, in accordance with the received graphing request, such that the generated graph template specifies the data plot and the at least one data table; and
providing the graph template to a rendering engine of the graphing computer system, such that the rendering engine generates the graph display and produces the data plot such that the produced data plot includes plot points located relative to the horizontal axis of the data plot identified by the horizontal axis name and relative to the vertical axis of the data plot identified by the vertical axis name and includes textual representation of the data table aligned with the horizontal or vertical axis.

In accordance with the teachings provided herein, systems and methods for generating a graph display that includes a data plot and at least one data table in response to a received graphing request to generate a graph display, wherein the graphing request specifies at least one pairing of an axis name and a table column name. The data plot of the generated graph display includes plot points located relative to a horizontal axis of the data plot identified by a horizontal axis name and located relative to a vertical axis of the data plot identified by a vertical axis name, and either the horizontal axis name or the vertical axis name corresponds to the axis name of the at least one pairing in the graphing request. In response to the received graphing request, a graph template of the graph display is generated, such that the generated graph template specifies the data plot and the at least one data table. The graph template is provided to a rendering engine of the graphing computer system, and the rendering engine generates the graph display and produces the data plot such that the produced data plot includes plot points located relative to the horizontal axis of the data plot identified by the horizontal axis name and relative to the vertical axis of the data plot identified by the vertical axis name and textual representation of the data table aligned with the horizontal or vertical axis.

### BRIEF DESCRIPTION OF THE DRAWINGS

FIG. 1 illustrates a block diagram of an example of a computer-implemented environment for generating data graphs with tables of data that are automatically aligned with one or more graph axes.

FIG. 2 illustrates a block diagram of an example of a processing system of FIG. 1 for generating, by a graph generation engine, data graphs with automatically aligned tables of data.

FIG. 3 illustrates an example of a flow diagram for generating, by a graph generation engine, data graphs with automatically aligned tables of data using the system of FIGS. 1 and 2.

FIG. 4 illustrates another example of a flow diagram for generating, by a graph generation engine, data graphs with automatically aligned tables of data using the system of FIGS. 1 and 2.

FIG. 5 illustrates an example of a graph display with an aligned table within the data plot area of the graph display, produced in accordance with the disclosed system illustrated in FIGS. 1 and 2.

FIG. 6 illustrates an example of a graph display with an aligned table external to the data plot area of the graph display showing the preferred weight calculated by a lattice layout, produced in accordance with the disclosed system illustrated in FIGS. 1 and 2.

FIG. 7 illustrates an example of a graph display with multiple aligned tables in a “forest plot” arrangement, the tables external to the centered data plot, the graph display produced in accordance with the disclosed system illustrated in FIGS. 1 and 2.

FIG. 8 illustrates an example of a graph display with multiple aligned tables in a “forest plot” arrangement, the tables within the data plot area, the graph display produced in accordance with the disclosed system illustrated in FIGS. 1 and 2.

FIG. 9 illustrates an example of a graph display with an aligned table in a horizontal bar chart arrangement, produced in accordance with the disclosed system illustrated in FIGS. 1 and 2.

FIG. 10 illustrates an example of a graph display with an aligned table in a vertical bar chart arrangement, produced in accordance with the disclosed system illustrated in FIGS. 1 and 2.

FIG. 11 illustrates an example of a graph display with two aligned tables, one table aligned with the X axis and one table aligned with the Y axis in a bubble chart arrangement, produced in accordance with the disclosed system illustrated in FIGS. 1 and 2.

FIG. 12 illustrates an example of a graph display with an aligned table, having automatically generated spacing, produced in accordance with the disclosed system illustrated in FIGS. 1 and 2.

FIG. 13 illustrates an example of a graph display with an aligned table, having automatically generated spacing with indicated group classification, produced in accordance with the disclosed system illustrated in FIGS. 1 and 2.

FIG. 14 illustrates an example of a graph display with an aligned table, having automatically generated spacing, produced in accordance with the disclosed system illustrated in FIGS. 1 and 2.

Like reference numbers and designations in the various drawings indicate like elements.

### DETAILED DESCRIPTION

Current computer techniques for using graphing systems to generate a graph with an aligned table of statistics require the system user to create the graph for the data set and then manually insert the axis-aligned textual information into the graph using separate drawing commands. The system user may be required to review and select, from the data set on which the graph is based, those data values that will be included in the table. This process is not easily scalable and transferable to other data sets and graphs, requiring each display plot to be handled in a manner that is unique to the data and the plot.

This application discloses a system and associated techniques and methods for automatically generating and displaying graphs with data tables, such as tables of statistics, that are aligned with the graph axes. Some features disclosed herein include:
The system automates the task of placing rows or columns of numeric or character data strings that are aligned with values on the X axis or Y axis. This type of feature makes it easy to create plots like the Survival Plot or the Forest Plot.
Tables can have one or multiple rows (or columns) based on a class variable. Values for classifications can be stacked or clustered.
Multiple tables can be placed inside inner margins that automatically compute the required space and automatically arrange the rows of columns.
Multiple tables can be placed in lattice cells with a preferred weight. This allows the lattice to automatically determine the space needed for the text elements of the columns or rows.
Values can have different font characteristics by group.
Values can be freely indented for organization.
Numeric and character values have automatic justification that can be changed.
Column headers (labels) can be displayed with selection of text justification, splitting across lines, and alignment.
Column values (non-numeric) can be split across text lines and justified when the X axis is discrete.
Table header (or title) can be displayed.
Values can be color coded by color group variable, e.g., for traffic lighting.
Attributes for values can be controlled by a Discrete Attributes Map.
Numeric values may be summarized using a statistics computation option when the axis is discrete.
Separator lines can be shown between graph and inner margin, and inner margins can be on all four sides of the graph container.
Floating Text values can be displayed in the graph space by specifying the position along the orthogonal axis.

The features may be provided in a computer graphing system in which processes to produce the features are invoked using a graphing request to locate numeric and text string data adjacent a data plot in a graph display. For example, in a system that supports graphing techniques in accordance with applications software from SAS Institute Inc. (“SAS”) of Cary, N.C. USA, the features may be provided through an “axistable” statement, in which an AxisTable plot is generated.

For example, the study names and other data can be in a Forest plot or At-Risk tables can be in a Survival plot. It has many applications in the clinical and pharmaceutical industry. This type of “AxisTable” plot is also used by various commercially available procedures and techniques, such as those of the assignee, SAS, including SAS/STAT, SAS/ETS, and other SAS procedures, for example. These techniques help to replace the ASCII based table and bar graphs of conventional systems, which may require a user to carefully determine text layout and position, and can be tedious to generate.

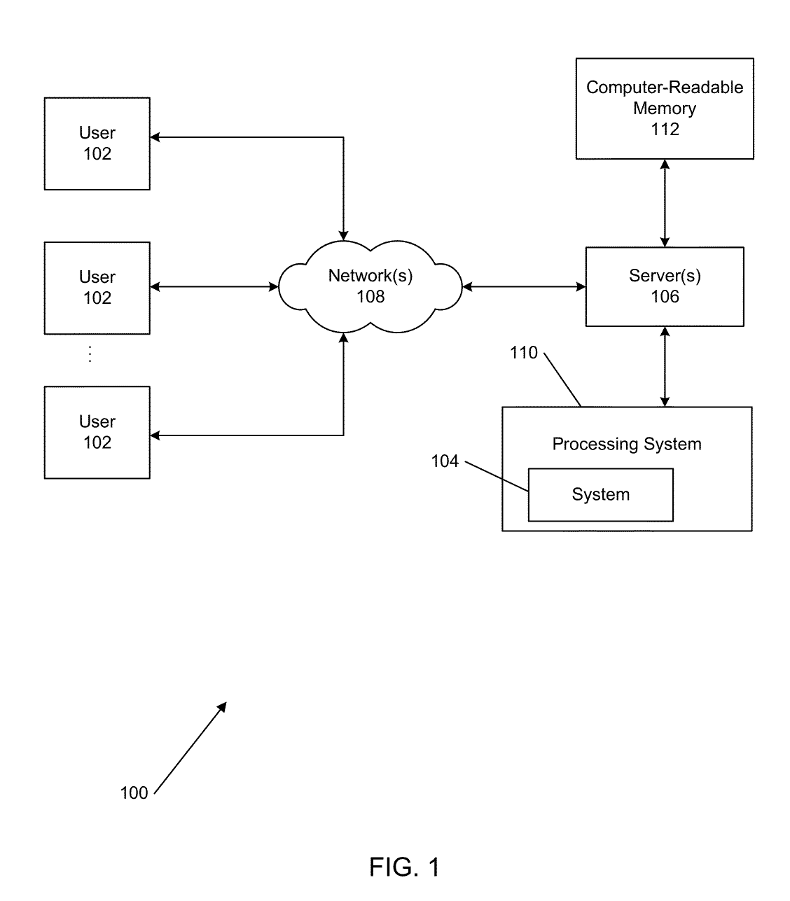

FIG. 1 illustrates a block diagram of an example of a computer-implemented environment 100 for generating data graphs with tables of data that are automatically aligned with one or more graph axes. Users 102 can interact with a computer system 104 through a number of ways, such as one or more servers 106 over one or more networks 108. The computer system 104 can contain software operations or routines. That is, the servers 106, which may be accessible through the networks 108, can host the computer system 104 in a client-server configuration. The computer system 104 can also be provided on a stand-alone computer for access by a user. The users may include, for example, a person at a terminal device who is requesting authorization for a financial transaction relating to an account.

In one example embodiment, the computer-implemented environment 100 may include a stand-alone computer architecture where a processing system 110 (e.g., one or more computer processors) includes the computer system 104 on which the processing system is being executed. The processing system 110 has access to a computer-readable memory 112. In another example embodiment, the computer-implemented environment 100 may include a client-server architecture, and/or a grid computing architecture. Users 102 may utilize a personal computer (PC) or the like to access servers 106 running a computer system 104 on a processing system 110 via the networks 108. The servers 106 may access a computer-readable memory 112.

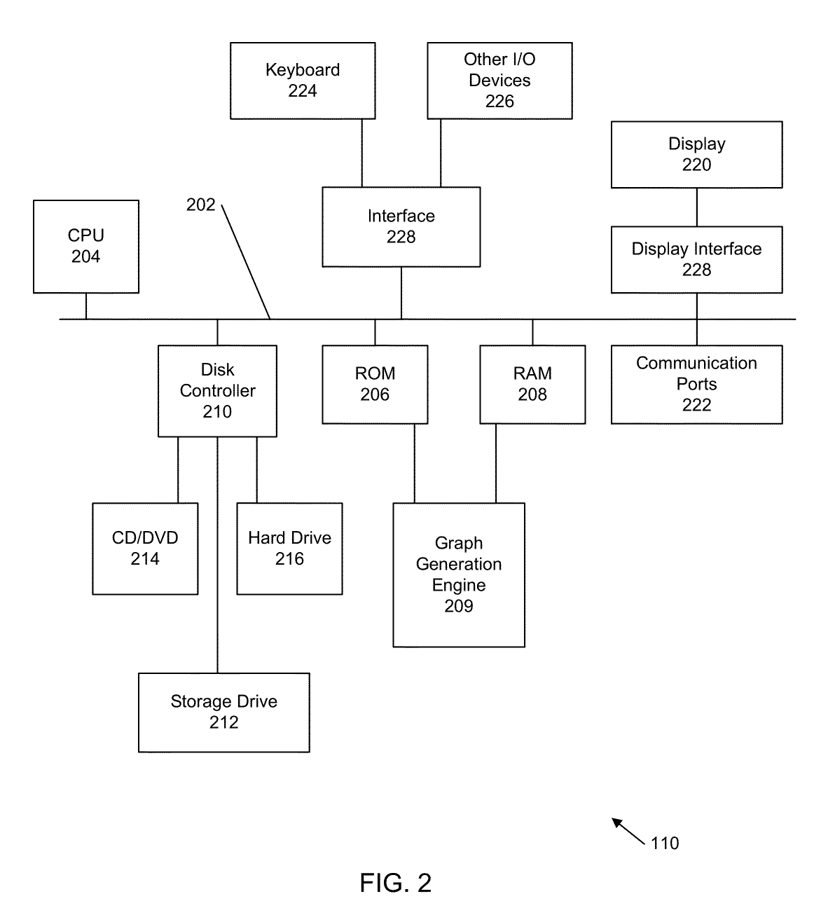

FIG. 2 illustrates a block diagram of an example of a processing system of FIG. 1 for generating data graphs with tables of data that are automatically aligned with one or more graph axes. A bus 202 may interconnect the other illustrated components of the processing system 110. A central processing unit (CPU) 204 (e.g., one or more computer processors) may perform calculations and logic operations used to execute a program. A processor-readable storage medium, such as read-only memory (ROM) 206 and random access memory (RAM) 208, may be in communication with the CPU 204 and may contain one or more programming instructions. Optionally, program instructions may be stored on a computer-readable storage medium, such as a magnetic disk, optical disk, recordable memory device, flash memory, or other physical storage medium. Computer instructions may also be communicated via a communications transmission, data stream, or a modulated carrier wave. In one example, program instructions implementing a transaction processing engine 209, as described further in this description, may be stored on storage drive 212, hard drive 216, read only memory (ROM) 206, random access memory (RAM) 208, or may exist as a stand-alone service external to the stand-alone computer architecture.

A disk controller 210 can interface one or more optional disk drives to the bus 202. These disk drives may be external or internal floppy disk drives such as the storage drive 212, external or internal CD-ROM, CD-R, CD-RW, or DVD drives 214, or external or internal hard drive 216. As indicated previously, these various disk drives and disk controllers are optional devices.

A display interface 218 may permit information from the bus 202 to be displayed on a display 220 in audio, graphic, or alphanumeric format. Communication with external devices may optionally occur using various communication ports 222. In addition to the standard computer-type components, the hardware may also include data input devices, such as a keyboard 224, or other input/output devices 226, such as a microphone, remote control, touchpad, keypad, stylus, motion, or gesture sensor, location sensor, still or video camera, pointer, mouse or joystick, which can obtain information from the bus 202 via an interface 228.

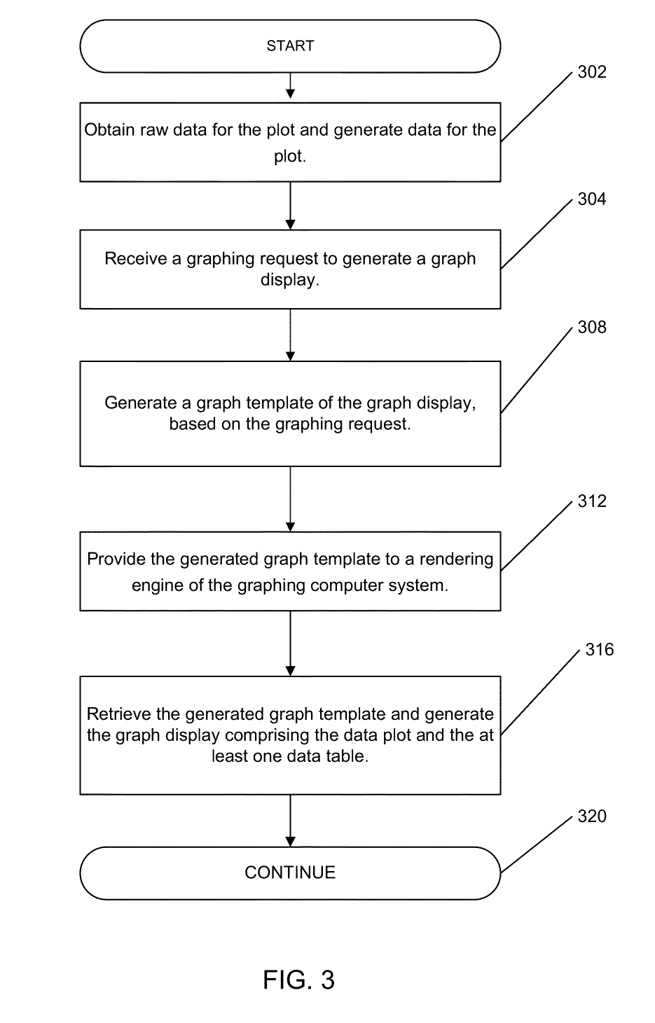

FIG. 3 illustrates an example of a flow diagram for generating, by a graph generation engine, data graphs with automatically aligned tables of data using the system of FIGS. 1 and 2. FIG. 3 shows that generating the graph is carried out in operations, also referred to as processes, in which data for a graph plot is obtained in one operation, the type of plot to be generated and display options, from which a template is generated, are specified in another operation, and in a final operation, the template and plot data are generated by a rendering engine.

In the first operation of FIG. 3, represented by the box 302, raw data for the graph is obtained and data for the plot is generated. This operation includes obtaining the raw numerical and/or text (e.g. alphanumeric) data from which a graph may be drawn and also includes generating plot data that can be used by the system to draw the graph.

In the next operation, represented by the box 304, the system receives a graphing request to generate a graph display comprising a data plot with one or more adjacent data tables. The graphing request may be referred to herein as an axistable request, which is a type of graphing request that is supported by application software available from SAS. The axistable request is but an example of a graphing request to initiate the operations described herein; the graphing request is not limited to the axistable exemplary request referred to in this disclosure. The axistable request specifies at least one pairing of an axis name and a table column name. The generated graph display includes a data plot and at least one data table, and the data plot of the generated graph display includes plot points located relative to a horizontal axis of the data plot identified by a horizontal axis name and plot points located relative to a vertical axis of the data plot identified by a vertical axis name and textual representation of the data table aligned with the horizontal or vertical axis. Either the horizontal axis name or the vertical axis name corresponds to the axis name of the at least one pairing in the graphing request. The sequence of box 302 and box 304 may be reversed or performed in parallel, as system resources and user preferences dictate.

In the next operation, at box 308 of FIG. 3, the system generates a graph template of the graph display, in accordance with the received graphing request, such that the generated graph template specifies the data plot and the at least one data table. That is, the graph display includes a data plot of values or statistics based on the data set. More particularly, the data plot is determined by values of a first subset of the data set that corresponds to a horizontal axis name, and by values of a second subset of the data set that corresponds to a vertical axis name.

In the next operation of FIG. 3, represented by the box 312, the system provides the generated graph template to a rendering engine of the graphing computer system. In the next operation, at box 316 of FIG. 3, the system, via the rendering engine, generates the graph display and produces the data plot such that the produced data plot includes plot points located relative to the horizontal axis of the data plot identified by the horizontal axis name and relative to the vertical axis of the data plot identified by the vertical axis name. That is, the rendering engine, in accordance with the graph template, generates at least one data table comprising text data values from the data set and places the data table relative to the data plot and the named axes. System operation then continues at the box 320.

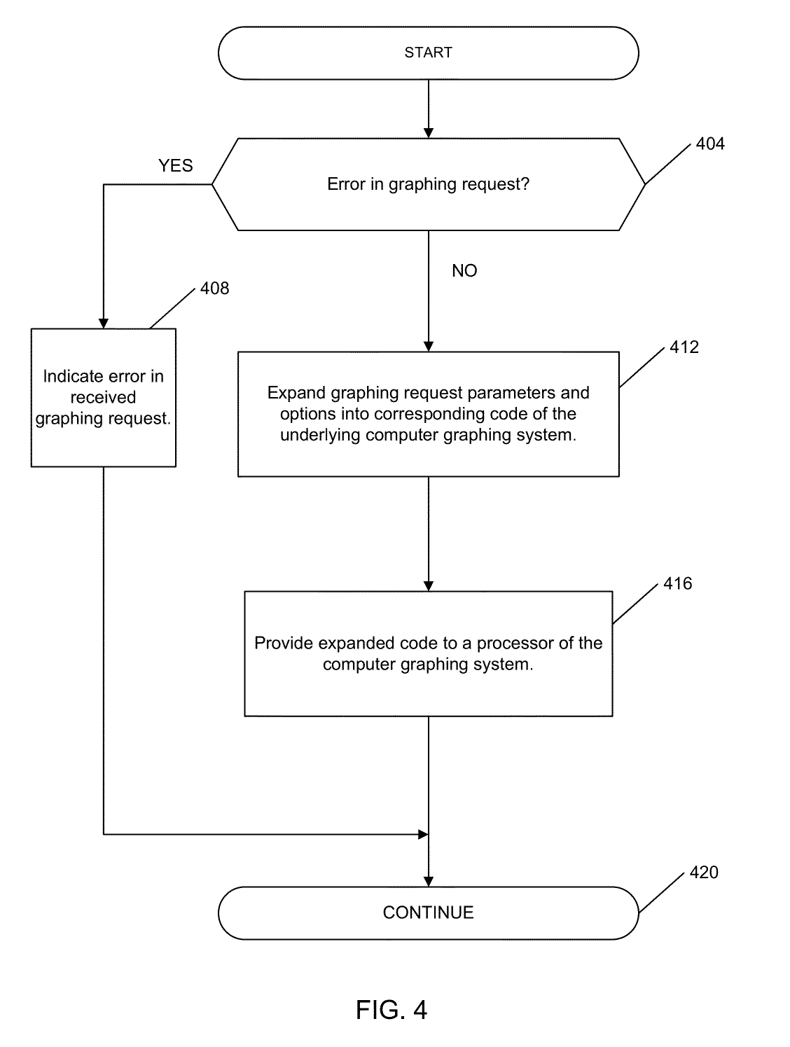

FIG. 4 illustrates another example of a flow diagram for generating, by a graph generation engine, a number of graphs related to a data set via the system of FIGS. 1 and 2. More particularly, FIG. 4 illustrates details of the operation in box 304 of FIG. 3 in processing a received graphing request, such as an axistable request, referred to above. In the first operation of FIG. 4, at the decision box 404, the system determines if there is an error in the axistable request. If there is an error, such as an error in syntax or a missing parameter input, an affirmative outcome at the decision box 404, the next operation performed is at the box 408, where the system indicates an error in the received axistable request. Operation then continues at the box 420, where the system exits the graph request.

If there is no error in the received axistable request, a negative outcome at the decision box 404, the next operation performed is for the system to generate code of the underlying computer graphing system that corresponds to the axis table request parameters and options. The code generating operation is represented by the box 412 of FIG. 4. The generated code will depend on the instruction set and commands used and understood by the underlying computer graphing system.

At the next operation, at box 416 of FIG. 4, the system provides the generated code to a processor of the computer graphing system. Operation of the system then continues with the box 420 operation.

The operation of the system to produce a graph display with automatically aligned data tables may be summarized by the operations listed in TABLE 1 below:

TABLE 1
Obtain raw data for the plot.
Generate data for the plot.
Generate a graph template of the graph display, based on a graphing
request and the plot data.
Render the graph display comprising the data plot and aligned data table.

The program code for the TABLE 1 operations may be specified at a user computer terminal of the system via a command line interface or a graphical user interface. Examples of the command line code for illustrated graph displays are provided below in accordance with applications software and graphing systems from SAS Institute, Inc. as mentioned above. Those skilled in the art will understand how to implement such code in graphing systems and will understand how to specify and implement corresponding code that would be used in similar graphing systems.

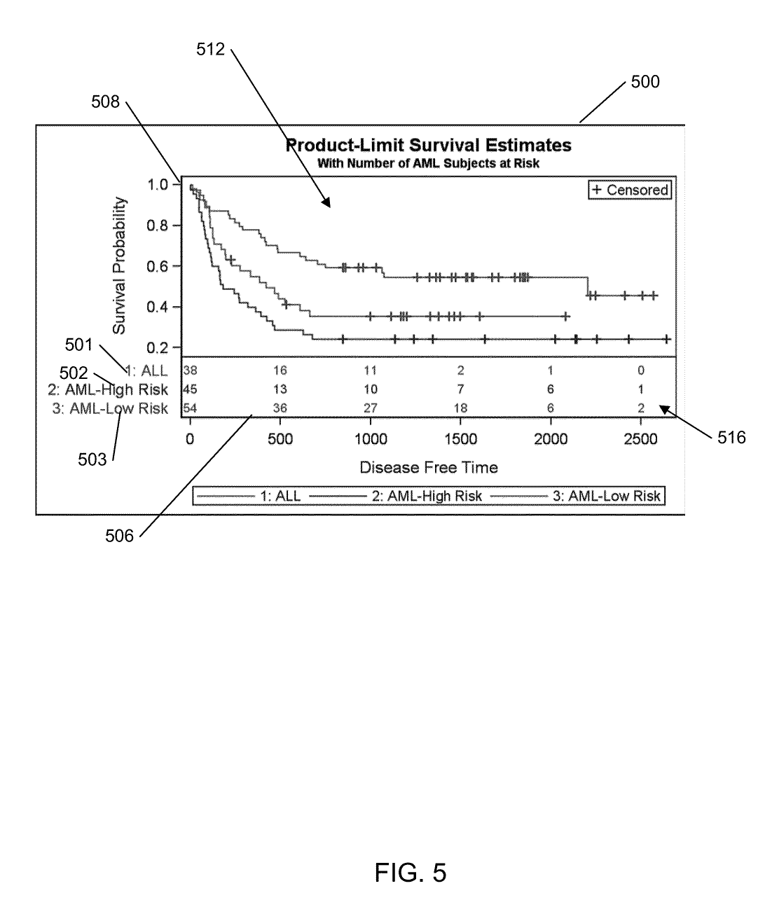

Oftentimes for graphs, especially those used in the clinical and pharmaceutical domains, it may be helpful to display textual statistical information that is aligned with the X or Y axis. Such an example is shown in the FIG. 5 graph display 500 of a survival plot. FIG. 5 illustrates an example of a graph display with an aligned table within the data plot area of the graph display, produced in accordance with the disclosed system illustrated in FIGS. 1 and 2. The data plot relates to risk cases for cancer, characterized as acute lymphocytic leukemia (ALL) or acute myelogenous leukemia (AML). The number of subjects at risk are displayed for the three risk cases at the bottom of the Survival Plot graph indicated as an “ALL” risk 501, an “AML-High” risk 502, and an “AML-Low” risk 503. The graph display 500 may appear, for example, on a display device of the graphing system 100 (see FIG. 1).

The illustrated graph display 500 shows an X-axis 506 with index units, or index values, shown along the X-axis as 0, 500, 1000, . . . , 2500 identified with the legend “Disease Free Time”. The illustrated graph display shows a Y-axis 508 with index units, or index values, shown along the Y-axis as 0.0, 0.2, 0.4, 0.6, . . . , 1.0 identified with the legend “Survival Probability”. The X-axis 506 and Y-axis 508 define a data plot area 512 in which values from a dataset are plotted. A data table 516 is located adjacent the X-axis and includes three rows of data parallel to the X-axis, with one column of data at each of the X-axis index units. The data in the data table 516 relates to the three types of risk, called ALL risk 501, AML-High risk 502, and AML-Low risk 503. The top-most curve in the data plot area 512 corresponds to the AML-Low Risk data, the middle curve corresponds to the ALL data, and the bottom-most curve corresponds to the AML-High Risk data.

In accordance with the disclosure, and with reference to the operations of FIG. 3, the FIG. 5 graph display is generated with two process calls of the graphing system, a template process and a rendering process. The processes may be called from a system display device using a command line type of interface, or using a graphical user interface (GUI). The graphing system that produces the graph displays illustrated herein may use, for example, a graphing template language to specify a command line interface specification that can produce the desired graph displays, such as those illustrated herein. One such computer language for specifying graph displays may comprise, for example, the “Graph Template Language” (GTL) that is utilized by the assignee of the present disclosure, SAS. The GTL of SAS implements a command line interface, and can also be implemented and accessed via a GUI presentation on a computer display of the graphing system.

In command line format, for example, the first operation of TABLE 1, Obtain raw data for the plot, may be initiated with command line code such as listed in TABLE 2 below to produce the graph plot of FIG. 5:

TABLE 2
%let gpath=‘.’;
%let dpi=200;
ods html close;
ods listing gpath=&gpath image_dpi=&dpi;
/*--This sample uses data from sample 49_2_1--*/
proc format;

value risk 1=‘ALL’ 2=‘AML-Low Risk’ 3=‘AML-High Risk’;

/*--Data for proc LIFETEST sample 49_2_1--*/
data BMT;

input Group T Status @@;
format Group risk.;
label T=‘Disease Free Time’;
datalines;

1 2081 0 1 1602 0 1 1496 0 1 1462 0 1 1433 0
1 1377 0 1 1330 0 1 996 0 1 226 0 1 1199 0
1 1111 0 1 530 0 1 1182 0 1 1167 0 1 418 1
1 383 1 1 276 1 1 104 1 1 609 1 1 172 1
1 487 1 1 662 1 1 194 1 1 230 1 1 526 1
1 122 1 1 129 1 1 74 1 1 122 1 1 86 1
1 466 1 1 192 1 1 109 1 1 55 1 1 1 1
1 107 1 1 110 1 1 332 1 2 2569 0 2 2506 0
2 2409 0 2 2218 0 2 1857 0 2 1829 0 2 1562 0
2 1470 0 2 1363 0 2 1030 0 2 860 0 2 1258 0
2 2246 0 2 1870 0 2 1799 0 2 1709 0 2 1674 0
2 1568 0 2 1527 0 2 1324 0 2 957 0 2 932 0
2 847 0 2 848 0 2 1850 0 2 1843 0 2 1535 0
2 1447 0 2 1384 0 2 414 1 2 2204 1 2 1063 1
2 481 1 2 105 1 2 641 1 2 390 1 2 288 1
2 421 1 2 79 1 2 748 1 2 486 1 2 48 1
2 272 1 2 1074 1 2 381 1 2 10 1 2 53 1
2 80 1 2 35 1 2 248 1 2 704 1 2 211 1
2 219 1 2 606 1 3 2640 0 3 2430 0 3 2252 0
3 2140 0 3 2133 0 3 1238 0 3 1631 0 3 2024 0
3 1345 0 3 1136 0 3 845 0 3 422 1 3 162 1
3 84 1 3 100 1 3 2 1 3 47 1 3 242 1
3 456 1 3 268 1 3 318 1 3 32 1 3 467 1
3 47 1 3 390 1 3 183 1 3 105 1 3 115 1
3 164 1 3 93 1 3 120 1 3 80 1 3 677 1
3 64 1 3 168 1 3 74 1 3 16 1 3 157 1
3 625 1 3 48 1 3 273 1 3 63 1 3 76 1
3 113 1 3 363 1
;
ods html close;
ods listing close;
ods graphics on;

In the TABLE 2 code above, it can be seen that the three data sets are specified, comprising ALL data, AML-Low Risk data, and AML-High Risk data. Those skilled in the art will appreciate that some of the lines of code in TABLE 2, such as format specifications, process calls, and calls to an output display system (ods) and the like, are unique to the operating environment of the SAS system referred to above. Those skilled in the art will understand corresponding code that would be utilized in other graphing systems.

In command line format, for example, the second operation of TABLE 1, Generate data for the plot, may be initiated with command line code such as listed in TABLE 3 below to produce the graph plot of FIG. 5:

TABLE 3

/*--Get survival plot data from LIFETEST procedure--*/
ods output Survivalplot=SurvivalPlotData;
proc lifetest data=BMT plots=survival(atrisk=0 to 2500 by 500);

time T * Status(0);
strata Group / test=logrank adjust=sidak;
run;

ods listing gpath=&gpath image_dpi=&dpi;

Those skilled in the art will appreciate that some of the lines of code in TABLE 3, such as format specifications, process calls, and calls to an output display system (ods) and the like, are unique to the operating environment of the SAS system referred to above. Those skilled in the art will understand corresponding code that would be utilized in other graphing systems.

In command line format, for example, the third operation of TABLE 1, Generate a graph template of the graph display, based on a graphing request and the plot data, may be initiated with command line code such as listed in TABLE 4 below to produce the graph plot of FIG. 5:

TABLE 4
/*--Template for Survival Plot with inner Axis Table--*/
proc template;
define statgraph Survival_Inside;

begingraph;
entrytitle ‘Product-Limit Survival Estimates’;

```
  entrytitle ‘With Number of AML Subjects at Risk’ /
  textattrs=(size=7);
```

layout overlay;

stepplot x=time y=survival / group=stratum
lineattrs=(pattern=solid)

name=‘s’;

scatterplot x=time y=censored / markerattrs=(symbol=plus)
name=‘c’;
scatterplot x=time y=censored / markerattrs=(symbol=plus)

GROUP=stratum;

```
innermargin / separator=true;
  axistable x=tatrisk value=atrisk / class=stratum
  colorgroup=stratum;
```

endinnermargin;

discretelegend ‘c’ / location=inside autoalign=(topright);
discretelegend ‘s’;
endlayout;
endgraph;

end;
run;

Those skilled in the art will appreciate that some of the lines of code in TABLE 4, such as format specifications, process calls, and calls to an output display system (ods) and the like, are unique to the operating environment of the SAS system referred to above. Those skilled in the art will understand corresponding code that would be utilized in other graphing systems.

The generated template code is not listed here, because the generated template code will be different for different computer graphing systems, and the code for a particular computer graphing system will be known to those skilled in the art for their particular system, without further description.

The TABLE 4 code shows a command line format listing for a process called “proc template” that will generate the graph template for producing the axis table graph display. The code specifies a “statgraph” format of data plot. In general, any code for an axistable template may specify two types of axis tables, an axis table aligned with either the X-axis or the Y-axis, or two tables, aligned with both axes. The “axistable” specification has the following format:
axistable X=column|expression value=column|expression </option(s)>;
axistable Y=column|expression value=column|expression </option(s)>;
   That is, the graph plot will include a data table that is aligned with either the X-axis or the Y-axis, depending on which axis is identified in the statement. For example, if the X-axis is specified, then the “axistable X” statement will specify a column or expression for the index values along the X-axis of the plot, with which the values of the data table will be aligned. In the example code of TABLE 4, there is one axistable request, for an axis data table aligned with the X-axis.

In the FIG. 5 example, the X values will be specified for the label (expression) of “Disease Free Time”, as can be seen in FIG. 5. In addition to specifying the axis for alignment, either X or Y generally, the axistable statement also specifies the values (i.e., labels) for the rows (or columns) of the data table. In the FIG. 5 example, the data table 516 row values will be specified with the label (expression) of the data table rows, comprising ALL risk 501, AML-High risk 502, and AML-Low risk 503, as can be seen in FIG. 5. These values are specified in the plot code of TABLE 2. The axistable statement may also include selected options. The options that may be selected will depend on the capabilities of the computer graphing system.

Following the template specification, the generated template code and corresponding data are delivered to a rendering engine, which generates the graph display on a display device of the graphing system. In command line format, for example, the last operation of TABLE 1, Render the graph display comprising the data plot and aligned data table, may be initiated with command line code such as listed in TABLE 5 below to produce the graph plot of FIG. 5:

TABLE 5

/*--Render Survival Plot with inner Axis Table--*/
ods graphics / reset maxlegendarea=50 width=5in height=3in
imagename=‘Fig5_SurvivalPlot_AxisTable_Inside_94_GTL’;
proc sgrender data=SurvivalPlotData template=Survival_Inside;
run;

Those skilled in the art will appreciate that some of the lines of code in TABLE 5, such as format specifications, process calls, and calls to an output display system (ods) and the like, are unique to the operating environment of the SAS Institute, Inc. system referred to above. Those skilled in the art will understand corresponding code that would be utilized in other graphing systems.

Oftentimes it is desirable that the data table information 516 is not displayed within the data plot area (above the horizontal X-axis) as in FIG. 5, but rather is displayed external to the data plot area 512, below the horizontal X-axis 506 in FIG. 5.

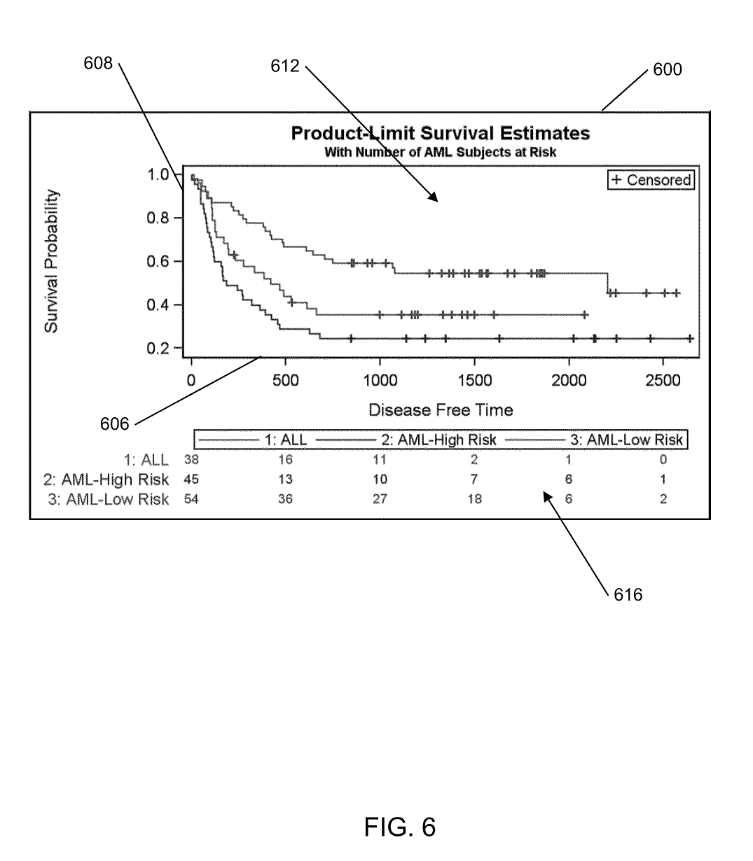

FIG. 6 illustrates an example of a graph display 600 having a data plot with an X-axis 606 and a Y-axis 608 that define a plot area 612, with an aligned table 616 that is external to the data plot area of the graph display. The display is produced in accordance with the disclosed system illustrated in FIGS. 1 and 2. Even though the data table 616 is located external to the data plot area 612, the data table values of the at-risk data are correctly aligned by the computer graphing system relative to the X-axis index units. It should be noted that the axistable statements of TABLE 4 could be configured to position a data table adjacent to the Y-axis, either within the data plot area or external to the data plot area. Those skilled in the art will understand how to fashion suitable axistable statements, based on the disclosure herein.

Changing the placement of the data table to be external to the data plot, as in FIG. 6, can be achieved with modification to the code for generating the graph template. Thus, to generate the graph display of FIG. 6, in command line format, for example, the code for generating the graph template with an outer axis data table, based on a graphing request and the plot data of TABLES 2 and 3, may be initiated with command line code such as listed in TABLE 6 below to produce the graph plot of FIG. 6:

TABLE 6

/*--Template for Survival Plot with outer Axis Table--*/
proc template;
define statgraph Survival_Outside;

begingraph;
entrytitle ‘Product-Limit Survival Estimates’;

```
  entrytitle ‘With Number of AML Subjects at Risk’ /
  textattrs=(size=7);
```

```
  layout lattice / rowweights=(preferred preferred)
  columndatarange=union;
```

```
layout overlay;
  stepplot x=time y=survival / group=stratum
  lineattrs=(pattern=solid)
```

name=‘s’;

```
  scatterplot x=time y=censored /
  markerattrs=(symbol=plus) name=‘c’;
  scatterplot x=time y=censored /
  markerattrs=(symbol=plus)
```

GROUP=stratum;

```
  discretelegend ‘c’ / location=inside
  autoalign=(topright);
  discretelegend ‘s’;
```

endlayout;

```
layout overlay / xaxisopts=(display=none)
walldisplay=none border=false;
  axistable x=tatrisk value=atrisk /
  class=stratum colorgroup=stratum;
```

endlayout;;

endlayout;
endgraph;

end;
run;

Those skilled in the art will appreciate that some of the lines of code in TABLE 6, such as format specifications, process calls, and calls to an output display system (ods) and the like, are unique to the operating environment of the SAS system referred to above. Those skilled in the art will understand corresponding code that would be utilized in other graphing systems.

The generated template code is not listed here, because the generated template code will be different for different computer graphing systems, and the code for a particular computer graphing system will be known to those skilled in the art for their particular system, without further description.

The rendering operation to produce the FIG. 6 graph display would then be specified by code such as provided in TABLE 7 below:

TABLE 7

/*--Render Survival Plot with Outer Axis Table--*/
ods graphics / reset maxlegendarea=50 width=5in height=3in
imagename=‘Fig6_SurvivalPlot_AxisTable_Outside_94_GTL’;
proc sgrender data=SurvivalPlotData template=Survival_Outside;
run;

Those skilled in the art will appreciate that some of the lines of code in TABLE 7, such as format specifications, process calls, and calls to an output display system (ods) and the like, are unique to the operating environment of the SAS system referred to above. Those skilled in the art will understand corresponding code that would be utilized in other graphing systems.

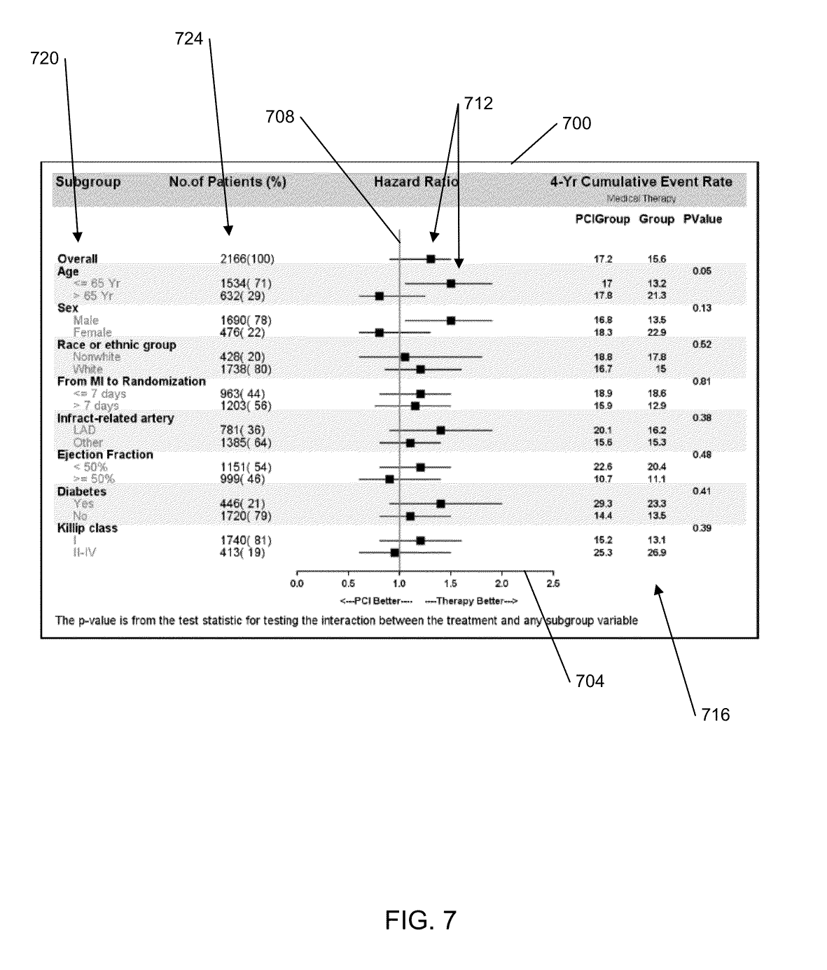

FIG. 7 illustrates an example of a graph display 700 with multiple aligned tables in a “forest plot” arrangement, the tables being located external to the centered data plot, the graph display being produced in accordance with the disclosed system illustrated in FIGS. 1 and 2. In the case of the FIG. 7 forest plot, the “Hazard Ratio” for each study is displayed in the center of the display. The study names are assigned to the Y-axis, but the display of the axis itself is suppressed. The study names and other pertinent text information is displayed as data tables located on either side of the data plot that is centered in the graph display using the same y axis as the main plot. Each data table includes a title, such as “Subgroup”, “No. of Patients (%)”, and “4-Yr Cumulative Event Rate”, wherein each title can be specified in the axistable request. Since all plots have the same Y-axis variable, the graphing system automatically correctly aligns the data values in the columns and rows of the data tables with the corresponding values on the y-axis of the data plot. In the illustrated graph display, the tables are located in separate columns of a Three-Column Lattice Layout adjacent the centered data plot. The text in the data tables and the text in the titles is shown in a combination of regular type face and bold type face. Such type face selections may be specified in the template process listing.

Specifying multiple data tables to be included in the graph display, such as illustrated in FIG. 7, is relatively easily achieved in the disclosed graphing system. An arrangement of command line code corresponding to the operations listed in TABLE 1 may be followed. In command line format, for example, the first operation of TABLE 1, Obtain raw data for the plot, may be initiated with command line code such as listed in TABLE 8 below to produce the graph plot of FIG. 7:

TABLE 8
%let
gpath=‘C:\Work\Patents\Disclosures\2014\GTL_Axis_Table\Image’;
%let dpi=200;
ods html close;
ods listing gpath=&gpath image_dpi=&dpi;
/*--To retain leading and trailing blanks, we must use nbsp instead of
blank--*/

| | |
|---|---|
| /*--For visibility, we have used ‘.’ in place of blanks | --*/ |
| /*-- Later these ‘.’ values are changed to nbsp ‘A0’x | --*/ |

/*--Regular leading blanks will be stripped, losing the

| | |
|---|---|
| indentation | --*/ |

| | |
|---|---|
| /*--Add “Id” to identify subgroup headings from values | --*/ |

data forest;

input Id Subgroup $3-27 Count Percent Mean Low High PCIGroup

Group PValue;

indentWt=1;
PCI_lbl=‘PCI Group’;
grp_lbl=‘Group’;
pval_lbl=‘P Value‘;
ObsId=_n_;
if count ne . then CountPct=put(count, 4.0) ∥ “(“ ∥ put(percent,
3.0) ∥ ”)”;
datalines;

1 Overall..................2166 100 1.3 0.9 1.5 17.2 15.6 .
1 Age....................... . . . . . . 0.05
2 ..<= 65 Yr...............1534 71 1.5 1.05 1.9 17.0 13.2 .
2 ..> 65 Yr................ 632 29 0.8 0.6 1.25 17.8 21.3 .
1 Sex........................ . . . . . . 0.13
2 ..Male...................1690 78 1.5 1.05 1.9 16.8 13.5 .
2 ..Female................. 476 22 0.8 0.6 1.3 18.3 22.9 .
1 Race or ethnic group...... . . . . . . 0.52
2 ..Nonwhite............... 428 20 1.05 0.6 1.8 18.8 17.8 .
2 ..White..................1738 80 1.2 0.85 1.6 16.7 15.0 .
1 From MI to Randomization.. . . . . . . 0.81
2 ..<= 7 days.............. 963 44 1.2 0.8 1.5 18.9 18.6 .
2 ..> 7 days...............1203 56 1.15 0.75 1.5 15.9 12.9 .
1 Infract-related artery.... . . . . . . 0.38
2 ..LAD.................... 781 36 1.4 0.9 1.9 20.1 16.2 .
2 ..Other..................1385 64 1.1 0.8 1.4 15.6 15.3 .
1 Ejection Fraction......... . . . . . . 0.48
2 ..< 50%..................1151 54 1.2 0.8 1.5 22.6 20.4 .
2 ..>= 50%................. 999 46 0.9 0.6 1.4 10.7 11.1 .
1 Diabetes.................. . . . . . . 0.41
2 ..Yes.................... 446 21 1.4 0.9 2.0 29.3 23.3 .
2 ..No.....................1720 79 1.1 0.8 1.5 14.4 13.5 .
1 Killip class.............. . . . . . . 0.39
2 ..I......................1740 81 1.2 0.8 1.6 15.2 13.1 .
2 ..II-IV.................. 413 19 0.95 0.6 1.5 25.3 26.9 .
;
run;
/*ods html;*/
/*proc print;run;*/
/*ods html close;*/
/*--Replace ‘.’ in subgroup with blank--*/
data forest2;

set forest;
subgroup=translate(subgroup, ‘ ’, ‘.’);
val=mod(_N_−1, 6);
if val eq 1 or val eq 2 or val eq 3 then ref=obsid;
/*--Indent value observations--*/
indentWt=ifn(id=1,0,1);
run;

ods html;
proc print;run;
ods html close;

In the TABLE 8 listing, not all the raw data is shown, to reduce the amount of code to be listed in this document. Although the command line code is provided, it should be understood that, as with all the command line code examples contained herein, a corresponding GUI change to permit such specification by the user is also easily achieved, and will be known by those skilled in the art in view of the description herein.

The second operation of TABE 1, Generate data for the plot, may be initiated with command line code such as listed in TABLE 9 below to produce the graph plot of FIG. 7:

TABLE 9
/*--Create font with smaller fonts for axis label, value and data--*/
proc template;
define style listingSF;

```
parent = Styles.Listing;
style GraphFonts from GraphFonts
  “Fonts used in graph styles” /
  ‘GraphDataFont’ = (“<sans-serif>, <MTsans-serif>”,7pt)
  ‘GraphValueFont’ = (“<sans-serif>, <MTsans-serif>”,7pt)
  ‘GraphLabelFont’ = (“<sans-serif>, <MTsans-serif>”,7pt, bold);
```

;
end;
run;
%let dpi=150;
ods listing style=listingSF gpath=&gpath image_dpi=&dpi;

Those skilled in the art will appreciate that some of the lines of code in Table 9, such as format specifications, process calls, and calls to an output display system (ods) and the like, are unique to the operating environment of the SAS system referred to above. Those skilled in the art will understand corresponding code that would be utilized in other graphing systems.

The third operation of TABLE 1, Generate a graph template of the graph display, based on a graphing request and the plot data, may be initiated with command line code such as listed in Table 10 below to produce the graph plot of FIG. 7:

TABLE 10
/*--Define template for Forest Plot--*/
/*--Template uses a Layout Lattice of 5 columns--*/
proc template;

define statgraph Forest_AxisTable;
dynamic _bandcolor _headercolor _subgroupcolor;

```
begingraph;
discreteattrmap name=‘text’ / ignorecase=true trimleading=true;
  value ‘1’ / textattrs=(size=7 weight=bold);
    value ‘2’ / textattrs=(color=gray size=6 weight=normal);
enddiscreteattrmap;
discreteattrvar attrvar=grp var=id attrmap=‘text’;
  layout lattice / columns=3 columnweights=(0.35 0.4 0.25);
```

/*--Column headers--*/

```
  sidebar / align=top;
  layout lattice / rows=2 columns=4 columnweights=(0.15 0.2 0.35 0.3)
```

backgroundcolor=_headercolor opaque=true;
entry textattrs=(size=8 weight=bold) halign=left “Subgroup”;

entry textattrs=(size=8 weight=bold) “ No.of Patients (%)”;

entry textattrs=(size=8 weight=bold) “Hazard Ratio”;
entry halign=center textattrs=(size=8 weight=bold) “4-Yr Cumulative

Event Rate” ;

entry “ ”;
entry “ ”;

entry “ ”;

entry halign=center textattrs=(size=6) “Medical Therapy”;
endlayout;

endsidebar;

| | |
|---|---|
| /*--First Subgroup column, shows only the Y2 axis | --*/ |

| /*--Use HighLow plot to place the heading and subgroup values as HighLabels--*/ | |
|---|---|
| /*--Indenting is done by making the 2nd highlow bar 1 unit long | --*/ |

| | |
|---|---|
| /*--Highlow bar itself has thickness=0 | --*/ |

layout overlay / walldisplay=none

```
  xaxisopts=(display=none)
  yaxisopts=(reverse=true display=none);
```

referenceline y=ref / lineattrs=(thickness=15 color=_bandcolor);
innermargin / align=left;
axistable y=obsid value=subgroup / textgroup=grp indentweight=indentwt

display=(values) valuehalign=center;

axistable y=obsid value=CountPct / display=(values) valuehalign=center;
endinnermargin;

endlayout;
/*--Second column showing odds ratio graph--*/
layout overlay / xaxisopts=(label=‘ <---PCI Better---- ----Therapy Better--->’

tickvalueattrs=(size=6 weight=bold) labelattrs=(size=6

weight=bold)

```
  linearopts=(tickvaluepriority=true
    tickvaluelist=(0.0 0.5 1.0 1.5 2.0 2.5)))
```

yaxisopts=(reverse=true display=none) walldisplay=none;
referenceline y=ref / lineattrs=(thickness=15 color=_bandcolor);

highlowplot y=obsid low=low high=high;
scatterplot y=obsid x=mean / markerattrs=(symbol=squarefilled);

referenceline x=1;

endlayout;
/*--Third column showing PCIGroup and Group columns--*/
layout overlay / xaxisopts=(display=none)

yaxisopts=(reverse=true display=none) walldisplay=none;

```
  referenceline y=ref / lineattrs=(thickness=15 color=_bandcolor);
innermargin / align=left;
  axistable y=obsid value=PCIGroup / display=(values label)
```

valueattrs=(size=6 weight=bold)

labelattrs=(size=7 weight=bold) valuehalign=center

showmissing=false ;

axistable y=obsid value=group / display=(values label) valueattrs=(size=6

weight=bold)

labelattrs=(size=7 weight=bold) valuehalign=center

showmissing=false ;

axistable y=obsid value=pvalue / display=(values label) valueattrs=(size=6

weight=bold)

labelattrs=(size=7 weight=bold) valuehalign=center

showmissing=false ;

endinnermargin;
endlayout;

endlayout;
entryfootnote halign=left textattrs=(size=7)

```
  ‘The p-value is from the test statistic for testing the interaction between the ’
  ‘treatment and any subgroup variable’;
```

endgraph;
end;
run;

Those skilled in the art will appreciate that some of the lines of code in TABLE 10, such as format specifications, process calls, and calls to an output display system (ods) and the like, are unique to the operating environment of the SAS system referred to above. Those skilled in the art will understand corresponding code that would be utilized in other graphing systems.

As was the case with the previous examples, following the template specification, the generated template code and corresponding data are delivered to a rendering engine, which generates the graph display on a display device of the graphing system. In command line format, for example, the last operation of TABLE 1, Render the graph display comprising the data plot and aligned data table, may be initiated with command line code such as listed in TABLE 11 below to produce the forest graph plot of FIG. 7:

TABLE 11

/*--Render Forest Plot with horizontal bands--*/
ods graphics / reset width=6in height=4in
imagename=‘Fig7_Forest_Subgroup_AxisTable_3Col_94’;
proc sgrender data=Forest2 template=Forest_AxisTable;
dynamic _bandcolor=‘cxf0f0f0’ _headercolor=‘cxd0d0d0’;
run;

Those skilled in the art will appreciate that some of the lines of code in TABLE 11, such as format specifications, process calls, and calls to an output display system (ods) and the like, are unique to the operating environment of the SAS system referred to above. Those skilled in the art will understand corresponding code that would be utilized in other graphing systems.

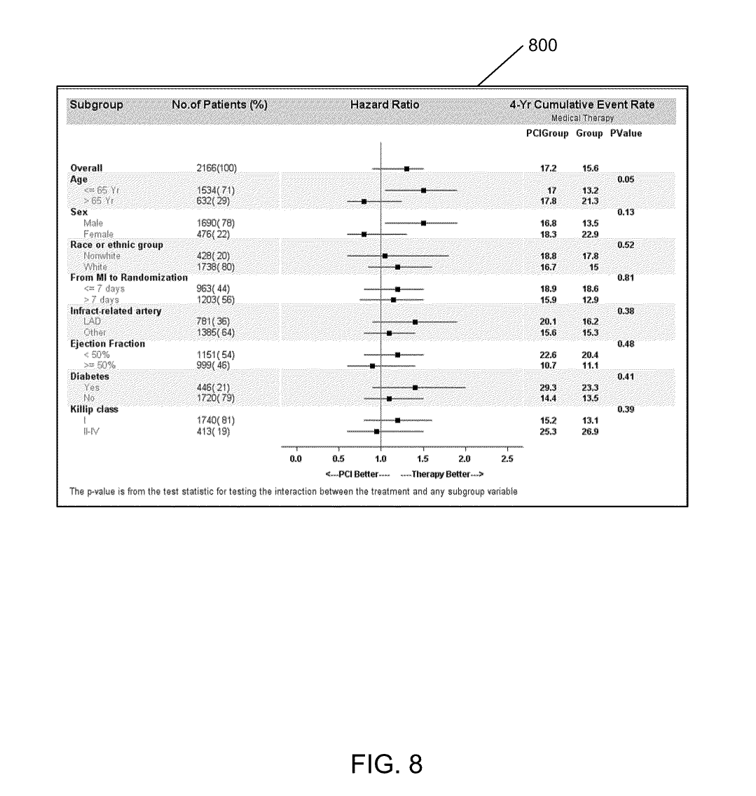

FIG. 8 illustrates an example of a graph display 800 with multiple aligned tables in a “forest plot” arrangement, similar to FIG. 7, except that the data tables are located within the data plot area. The location of the data tables within the data plot can be seen from the fact that the data tables are located adjacent the x-axis, which extends across the entire width of the display 800, and there are no breaks in the alternate horizontal bands. That is, FIG. 8 shows that the data tables are located within the left and right inner margins of a single graph, the single graph comprising the data plot area of the display graph. The graph display 800 of FIG. 8 is produced by the graphing system in accordance with the system illustrated in FIGS. 1 and 2.

With respect to the type face specification of the text in the graph display, the values may be justified and aligned according to user specification in the AxisTable Template or via alternative user interface specification, as known to those skilled in the art. That is, the values under each subgroup or other data arrangement in the graph display may be indented by a fixed amount that is set by user via the axistable specification. Each data table, as well as titles of rows and columns of the data table, may have its own indentation in inches or pixels, and such indentation may be independent of the type font.

Thus, to generate the graph display of FIG. 8, in command line format, for example, based on a graphing request and the plot data of TABLES 8 and 9, may be initiated with command line code such as listed in TABLE 12 below to produce the graph plot of FIG. 8:

TABLE 12
/*--Define template for Forest Plot--*/
/*--Template uses a Layout Lattice of 1 columns--*/
proc template;

define statgraph Forest_AxisTable_1Col;
dynamic _bandcolor _headercolor _subgroupcolor;

begingraph / axislineextent=data;
discreteattrmap name=‘text’ / ignorecase=true trimleading=true;

value ‘1’ / textattrs=(size=7 weight=bold);

value ‘2’ / textattrs=(color=gray size=6 weight=normal);

enddiscreteattrmap;
discreteattrvar attrvar=grp var=id attrmap=‘text’;

layout lattice;
/*--Column headers--*/

sidebar / align=top;
layout lattice / rows=2 columns=4 columnweights=(0.15 0.2 0.35 0.3)

backgroundcolor=_headercolor opaque=true;
entry textattrs=(size=8 weight=bold) halign=left “Subgroup”;

entry textattrs=(size=8 weight=bold) “ No.of Patients (%)”;

entry textattrs=(size=8 weight=bold) “Hazard Ratio”;
entry halign=center textattrs=(size=8 weight=bold) “4-Yr Cumulative

Event Rate” ;

entry “ ”;

entry “ ”;

entry “ ”;

entry halign=center textattrs=(size=6) “Medical Therapy”;
endlayout;

endsidebar;

/*--Single column showing odds ratio in middle and columns in inner

margins--*/

layout overlay / xaxisopts=(label=‘ <---PCI Better--- ---Therapy Better--->’

tickvalueattrs=(size=6 weight=bold) labelattrs=(size=6

weight=bold)

linearopts=(tickvaluepriority=true

tickvaluelist=(0.0 0.5 1.0 1.5 2.0 2.5)))

yaxisopts=(reverse=true display=none) walldisplay=none;

referenceline y=ref / lineattrs=(thickness=15 color=_bandcolor);

highlowplot y=obsid low=low high=high;

scatterplot y=obsid x=mean / markerattrs=(symbol=squarefilled);

referenceline x=1;

innermargin / align=left;

axistable y=obsid value=subgroup / textgroup=grp indentweight=indentwt

display=(values);

axistable y=obsid value=CountPct / display=(values);

endinnermargin;
innermargin / align=right pad=(right=20px);

axistable y=obsid value=PCIGroup / display=(values label)

valueattrs=(size=6 weight=bold)

labelattrs=(size=7 weight=bold) valuehalign=center

showmissing=false;

axistable y=obsid value=group / display=(values label)

valueattrs=(size=6 weight=bold)

labelattrs=(size=7 weight=bold) valuehalign=center

showmissing=false;

axistable y=obsid value=pvalue / display=(values label)

valueattrs=(size=6 weight=bold)

labelattrs=(size=7 weight=bold) valuehalign=center

showmissing=false;

endinnermargin;

endlayout;
endlayout;
entryfootnote halign=left textattrs=(size=7)

‘The p-value is from the test statistic for testing the interaction between the’
‘treatment and any subgroup variable’;

endgraph;

end;

run;

Those skilled in the art will appreciate that some of the lines of code in TABLE 12, such as format specifications, process calls, and calls to an output display system (ods) and the like, are unique to the operating environment of the SAS system referred to above. Those skilled in the art will understand corresponding code that would be utilized in other graphing systems.

As before with the previous examples, following the template specification, the generated template code and corresponding data are delivered to a rendering engine, which generates the graph display on a display device of the graphing system. In command line format, for example, the last operation of TABLE 1, Render the graph display comprising the data plot and aligned data table, may be initiated with command line code such as listed in TABLE 13 below to produce the forest graph plot of FIG. 8:

TABLE 13

/*--Render Forest Plot with 1 column--*/
ods graphics / reset width=6in height=4in
imagename=‘Fig8_Forest_Subgroup_AxisTable_1Col_94’;
proc sgrender data=Forest2 template=Forest_AxisTable_1Col;
dynamic _bandcolor=‘cxf0f0f0’ _headercolor=‘cxd0d0d0’;
run;

Those skilled in the art will appreciate that some of the lines of code in TABLE 13, such as format specifications, process calls, and calls to an output display system (ods) and the like, are unique to the operating environment of the SAS system referred to above. Those skilled in the art will understand corresponding code that would be utilized in other graphing systems.

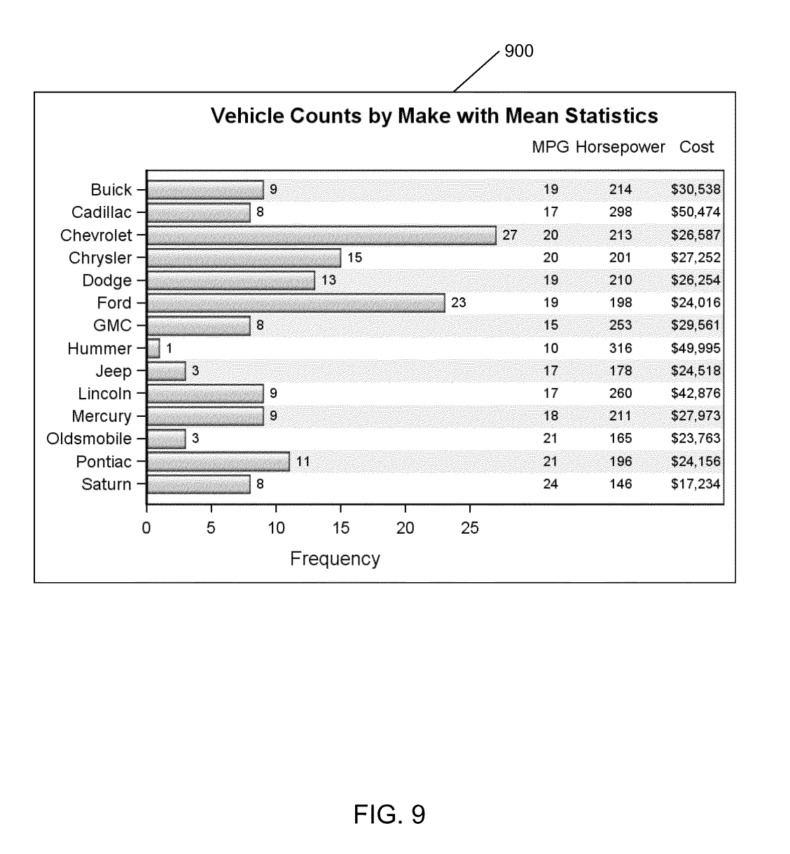

FIG. 9 illustrates an example of a graph display 900 with an aligned table in a bar chart arrangement, produced in accordance with the disclosed system illustrated in FIGS. 1 and 2. FIG. 9 shows a horizontal bar chart of the frequency counts by make for a data set comprising cars. In FIG. 9, the mean mileage, horsepower, and manufacturer suggested retail price (MSRP) cost are displayed on the right side of the data plot, in a three-column data table. These values are summarized by the plot statement (e.g., the mean in this example).

Specifying a bar chart arrangement with a data table aligned within the data plot area is relatively easily achieved in the graphing system. An arrangement of command line code corresponding to the operations listed in TABLE 1 may be followed. A corresponding GUI change to permit such specification by the user is also easily achieved, as will be known by those skilled in the art in view of the description herein. The first two operations of TABLE 1, relating to obtaining raw data and generating the plot data, are not listed herein, to simplify the presentation of information. The description provided thus far for the previous examples will be sufficient for those skilled in the art to understand the operations to be performed for producing FIG. 9.

The third operation of TABLE 1, Generate a graph template of the graph display, based on a graphing request and the plot data, may be initiated with command line code such as listed in TABLE 14 below to produce the graph plot of FIG. 9:

TABLE 14
/*--Y AxisTable with stat--*/
proc template;
define statgraph YAxisTable;

```
begingraph;
  entrytitle ‘Vehicle Counts by Make with Mean Statistics’;
  layout overlay / yaxisopts=(display=(ticks tickvalues) reverse=true
```

discreteopts=(colorbands=odd

colorbandsattrs=(transparency=0.5)));

barchart category=make / dataskin=gloss orient=horizontal
barlabel=true;

innermargin / align=right;

axistable y=make value=mpg_city / stat=mean display=(label)

valuehalign=center;

```
  axistable y=make value=horsepower /
  stat=mean display=(label)
```

valuehalign=center;

```
  axistable y=make value=msrp / stat=mean
  display=(label)
```

valuehalign=center;

endinnermargin;

endlayout;
endgraph;

end;
run;

Those skilled in the art will appreciate that some of the lines of code in TABLE 14, such as format specifications, process calls, and calls to an output display system (ods) and the like, are unique to the operating environment of the SAS system referred to above. Those skilled in the art will understand corresponding code that would be utilized in other graphing systems.

As before with the previous examples, following the template specification, the generated template code and corresponding data are delivered to a rendering engine, which generates the graph display on a display device of the graphing system. In command line format, for example, the last operation of TABLE 1, Render the graph display comprising the data plot and aligned data table, may be initiated with command line code such as listed in TABLE 15 below to produce the forest graph plot of FIG. 9:

TABLE 15

ods graphics / reset width=5in height=3.5in
imagename=‘Fig9_AxisTable_Y_Stat_GTL’;
proc sgrender
data=sashelp.cars(where=(origin=‘USA’))template=YAxisTable;

format mpg_city horsepower 3.0;
label msrp=‘Cost’ mpg_city=‘MPG’;

run;

Those skilled in the art will appreciate that some of the lines of code in TABLE 15, such as format specifications, process calls, and calls to an output display system (ods) and the like, are unique to the operating environment of the SAS system referred to above. Those skilled in the art will understand corresponding code that would be utilized in other graphing systems.

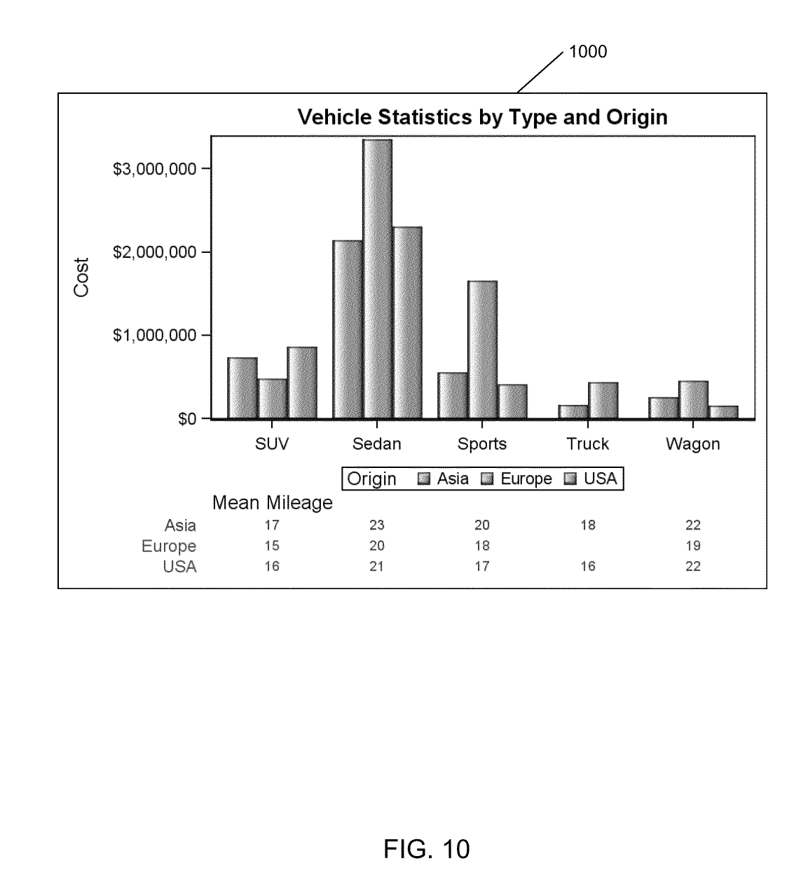

FIG. 10 illustrates an example of a graph display 1000 with an aligned table in a vertical bar chart arrangement, produced in accordance with the disclosed system illustrated in FIGS. 1 and 2. The graph display 1000 of FIG. 10 shows a vertical bar chart of MSRP by Type and Origin. Mean mileage by Origin is displayed below each bar, below the horizontal axis and the legend. Data values can also be clustered by the class variable. The table header (also referred to as title) is displayed above the table.

Specifying a graph display with a vertical bar chart arrangement is relatively easily achieved in the graphing system disclosed herein. For example, by simple modification to the AxisTable Template of the command line interface, the vertical bar chart arrangement may be specified. A corresponding GUI change to permit such specification by the user is also easily achieved, as will be known by those skilled in the art in view of the description herein. The first two operations of TABLE 1, relating to obtaining raw data and generating the plot data, are not listed herein, to simplify the presentation of information. The description provided thus far for the previous examples will be sufficient for those skilled in the art to understand the operations to be performed for producing FIG. 10.

The third operation of TABLE 1, Generate a graph template of the graph display, based on a graphing request and the plot data, may be initiated with command line code such as listed in TABLE 16 below to produce the graph plot of FIG. 10:

TABLE 16
/*--X AxisTable with stat--*/
proc template;
define statgraph XAxisTable;

```
begingraph;
  entrytitle ‘Vehicle Statistics by Type and Origin’;
  layout lattice / rowweights=(preferred preferred)
  columndatarange=union;
```

layout overlay / xaxisopts=(display=(ticks tickvalues));
barchart category=type response=msrp / stat=mean

group=origin groupdisplay=cluster dataskin=gloss name=‘a’;

discretelegend ‘a’;
endlayout;
layout overlay / walldisplay=none
xaxisopts=(display=none);

axistable x=type value=mpg_city / stat=mean class=origin

colorgroup=origin title=“Mean Mileage”;

endlayout;

endlayout;
endgraph;

end;
run;

Those skilled in the art will appreciate that some of the lines of code in TABLE 16, such as format specifications, process calls, and calls to an output display system (ods) and the like, are unique to the operating environment of the SAS system referred to above. Those skilled in the art will understand corresponding code that would be utilized in other graphing systems.

As before with the previous examples, following the template specification, the generated template code and corresponding data are delivered to a rendering engine, which generates the graph display on a display device of the graphing system. In command line format, for example, the last operation of TABLE 1, Render the graph display comprising the data plot and aligned data table, may be initiated with command line code such as listed in TABLE 17 below to produce the forest graph plot of FIG. 10:

TABLE 17
ods graphics / reset width=5in height=3.5in
imagename=‘Fig10_AxisTable_X_Stat_GTL’;
proc sgrender data=sashelp.cars(where=(type ne ‘Hybrid’))
template=XAxisTable;

format mpg_city horsepower 3.0;
label msrp=‘Mean MSRP’ mpg_city=‘MPG’;

run;
proc sort data=sashelp.cars(where=(type ne ‘Hybrid’)) out=carsSorted;
by origin type;
run;
proc means data=carsSorted noprint;

class origin type;
var mpg_city mpg_highway;
output out=carMeans(where=( _type_ = 3) )

mean(mpg_city mpg_highway ) = MpgCity MpgHwy
N (mpg_city mpg_highway ) = NCity NHwy

;
run;

/*proc print;run;*/

Those skilled in the art will appreciate that some of the lines of code in TABLE 17, such as format specifications, process calls, and calls to an output display system (ods) and the like, are unique to the operating environment of the SAS system referred to above. Those skilled in the art will understand corresponding code that would be utilized in other graphing systems.

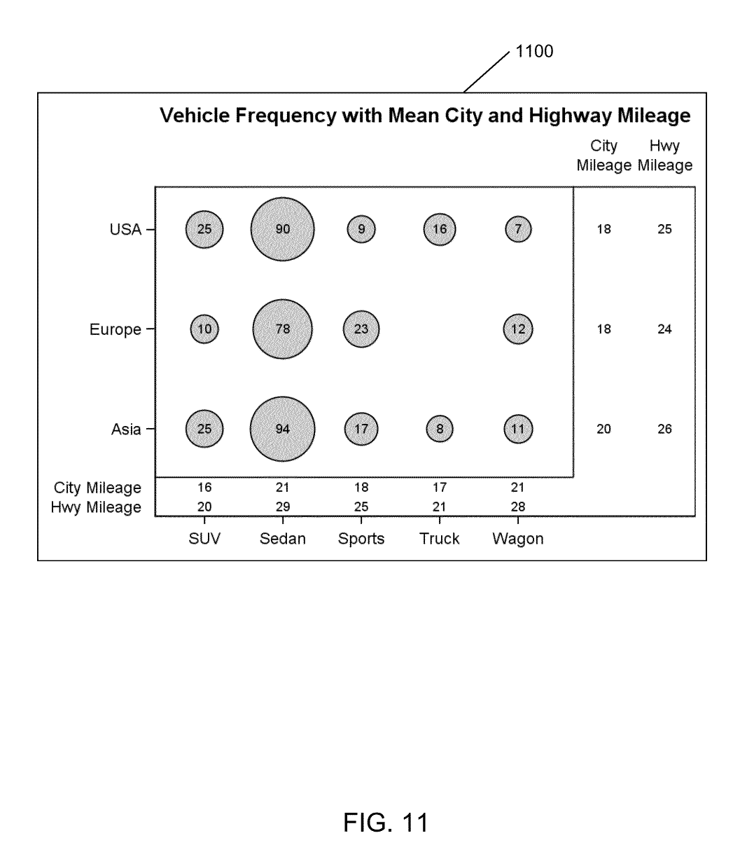

FIG. 11 illustrates an example of a graph display 1100 with two aligned tables in a bubble chart arrangement, produced in accordance with the disclosed system illustrated in FIGS. 1 and 2. The FIG. 11 graph display 1100 shows a bubble plot of the number of cars by Origin and Type along with the mean City and Highway Mileage by Origin and by Type.

Specifying a graph display with a bubble chart arrangement is relatively easily achieved in the graphing system disclosed herein. For example, by simple modification to the AxisTable Template of the command line interface, the bubble chart arrangement may be specified. A corresponding GUI change to permit such specification by the user is also easily achieved, as will be known by those skilled in the art in view of the description herein. The first two operations of TABLE 1, relating to obtaining raw data and generating the plot data, are not listed herein, to simplify the presentation of information. The description provided thus far for the previous examples will be sufficient for those skilled in the art to understand the operations to be performed for producing FIG. 11.

The third operation of TABLE 1, Generate a graph template of the graph display, based on a graphing request and the plot data, may be initiated with command line code such as listed in TABLE 18 below to produce the graph plot of FIG. 11:

TABLE 18
/*--Template for Bubble Plot with X and Y Axis Tables--*/
proc template;
define statgraph XYAxisTable;

```
begingraph;
  entrytitle ‘Vehicle Frequency with Mean City and Highway
  Mileage’;
  layout overlay / xaxisopts=(display=(ticks tickvalues))
```

yaxisopts=(display=(ticks tickvalues));

bubbleplot x=type y=origin size=ncity / bubbleradiusmin=10

bubbleradiusmax=25

name=‘b’ datalabel=ncity datalabelposition=center;

innermargin / align=bottom separator=true;

axistable x=type value=mpgCity / stat=mean;
axistable x=type value=mpgHwy / stat=mean;

```
  endinnermargin;
  innermargin / align=right separator=true;
```

axistable y=origin value=mpgCity / stat=mean

labelposition=max valuehalign=center;

axistable y=origin value=mpgHwy / stat=mean

labelposition=max valuehalign=center;

endinnermargin;

endlayout;

endgraph;

end;
run;

Those skilled in the art will appreciate that some of the lines of code in TABLE 18, such as format specifications, process calls, and calls to an output display system (ods) and the like, are unique to the operating environment of the SAS system referred to above. Those skilled in the art will understand corresponding code that would be utilized in other graphing systems.

As before with the previous examples, following the template specification, the generated template code and corresponding data are delivered to a rendering engine, which generates the graph display on a display device of the graphing system. In command line format, for example, the last operation of TABLE 1, Render the graph display comprising the data plot and aligned data table, may be initiated with command line code such as listed in TABLE 19 below to produce the forest graph plot of FIG. 11:

TABLE 19

/*--Render Bubble Plot with X and Y Axis Tables--*/
ods graphics / reset width=5in height=3.5in
imagename=‘Fig11_AxisTable_XY_Stat_GTL’;
proc sgrender data=carMeans2 template=XYAxisTable;

format MpgCity MpgHwy 3.0;
label MpgCity=‘City Mpg’ MpgHwy=‘Hwy Mpg’;

run;

Those skilled in the art will appreciate that some of the lines of code in TABLE 19, such as format specifications, process calls, and calls to an output display system (ods) and the like, are unique to the operating environment of the SAS system referred to above. Those skilled in the art will understand corresponding code that would be utilized in other graphing systems.

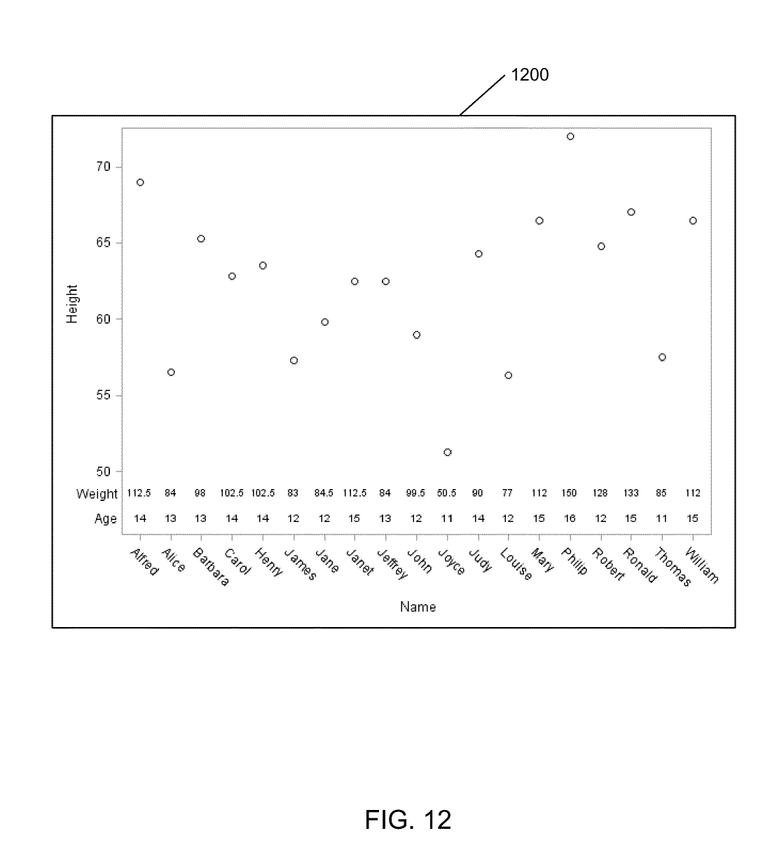

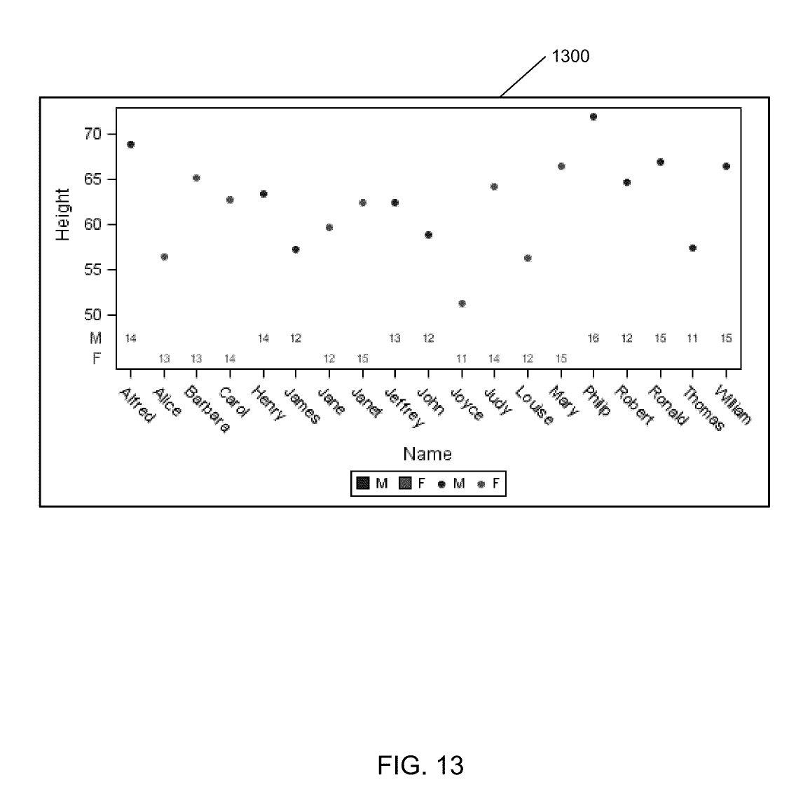

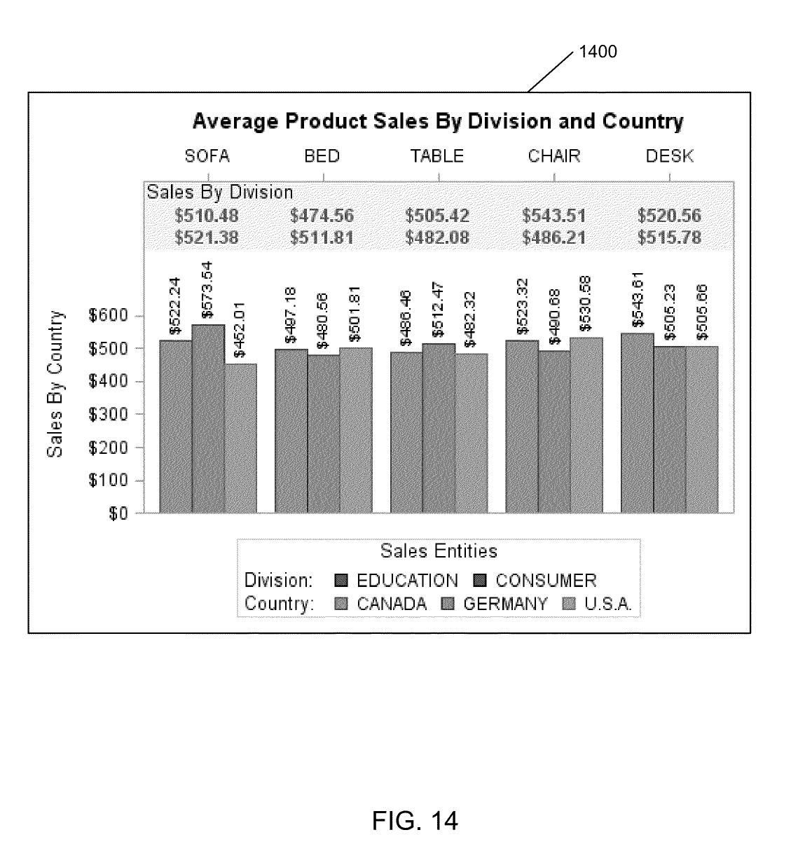

In some embodiments, each cell can have inner margins that are automatically generated, where there are reserved spaces on the side(s) of the graph. Examples of graph displays with inner margins are illustrated, for example, in FIGS. 12, 13, and 14.

In some examples described herein, the systems and methods may include data transmissions conveyed via networks (e.g., local area network, wide area network, Internet, or combinations thereof, etc.), fiber optic medium, carrier waves, wireless networks, etc. for communication with one or more data processing devices. The data transmissions can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein. Grid systems may be implemented as a multi-node Hadoop® cluster, as understood by a person of skill in the art. Apache™ Hadoop® is an open-source software framework for distributed computing.

### Embodiments

Systems and methods according to some examples may include data transmissions conveyed via networks (e.g., local area network, wide area network, Internet, or combinations thereof, etc.), fiber optic medium, carrier waves, wireless networks, etc. for communication with one or more data processing devices. The data transmissions can carry any or all of the data disclosed herein that is provided to, or from, a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The system and method data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, removable memory, flat files, temporary memory, databases, programming data structures, programming variables, IF-THEN (or similar type) statement constructs, etc.). It is noted that data structures may describe formats for use in organizing and storing data in databases, programs, memory, or other computer-readable media for use by a computer program.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows and figures described and shown in this specification can be performed by one or more programmable processors executing one or more computer programs to perform functions by operating on input data and generating output.

Generally, a computer can also include, or be operatively coupled to receive data from or transfer data to, or both, one or more mass storage devices for storing data (e.g., magnetic, magneto optical disks, or optical disks). However, a computer need not have such devices. Moreover, a computer can be embedded in another device, (e.g., a mobile telephone, a personal digital assistant (PDA), a tablet, a mobile viewing device, a mobile audio player, a Global Positioning System (GPS) receiver), to name just a few. Computer-readable media suitable for storing computer program instructions and data include all forms of nonvolatile memory, media and memory devices, including by way of example semiconductor memory devices (e.g., EPROM, EEPROM, and flash memory devices); magnetic disks (e.g., internal hard disks or removable disks; magneto optical disks; and CD ROM and DVD-ROM disks). The processor and the memory can be supplemented by, or incorporated in, special purpose logic circuitry.

The computer components, software modules, functions, data stores and data structures described herein may be connected directly or indirectly to each other in order to allow the flow of data needed for their operations. It is also noted that a module or processor includes, but is not limited to, a unit of code that performs a software operation, and can be implemented, for example, as a subroutine unit of code, or as a software function unit of code, or as an object (as in an object-oriented paradigm), or as an applet, or in a computer script language, or as another type of computer code. The software components or functionality may be located on a single computer or distributed across multiple computers depending upon the situation at hand.

The computer may include a programmable machine that performs high-speed processing of numbers, as well as of text, graphics, symbols, and sound. The computer can process, generate, or transform data. The computer includes a central processing unit that interprets and executes instructions; input devices, such as a keyboard, keypad, or a mouse, through which data and commands enter the computer; memory that enables the computer to store programs and data; and output devices, such as printers and display screens, that show the results after the computer has processed, generated, or transformed data.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products (i.e., one or more modules of computer program instructions encoded on a computer-readable medium for execution by, or to control the operation of, data processing apparatus). The computer-readable medium can be a machine-readable storage device, a machine-readable storage substrate, a memory device, a composition of matter effecting a machine-readable propagated, processed communication, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question (e.g., code that constitutes processor firmware, a protocol stack, a graphical system, a database management system, an operating system, or a combination of one or more of them).

While this disclosure may contain many specifics, these should not be construed as limitations on the scope of what may be claimed, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be utilized. Moreover, the separation of various system components in the implementations described above should not be understood as requiring such separation in all implementations, and it should be understood that the described program components and systems can generally be integrated together in a single software or hardware product or packaged into multiple software or hardware products.

Some systems may use Hadoop®, an open-source framework for storing and analyzing big data in a distributed computing environment. Some systems may use cloud computing, which can enable ubiquitous, convenient, on-demand network access to a shared pool of configurable computing resources (e.g., networks, servers, storage, applications and services) that can be rapidly provisioned and released with minimal management effort or service provider interaction. Some grid systems may be implemented as a multi-node Hadoop® cluster, as understood by a person of skill in the art. Apache™ Hadoop® is an open-source software framework for distributed computing. Some systems may use the SAS® LASR™ Analytic Server in order to deliver statistical modeling and machine learning capabilities in a highly interactive programming environment, which may enable multiple users to concurrently manage data, transform variables, perform exploratory analysis, build and compare models and score. Some systems may use SAS In-Memory Statistics for Hadoop® to read big data once and analyze it several times by persisting it in-memory for the entire session.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situations where only the disjunctive meaning may apply.

What is claimed is:

1. A computer-program product tangibly embodied in a non-transitory machine-readable storage medium, including instructions configured to be executed to cause a data processing apparatus of a graphing computer system to perform a method comprising:
receiving a graphing request to generate a graph display, wherein the graphing request specifies at least one pairing of an axis name and a table column name, wherein the generated graph display includes a data plot and at least one data table, and the data plot of the generated graph display includes plot points located relative to a horizontal axis of the data plot identified by a horizontal axis name and located relative to a vertical axis of the data plot identified by a vertical axis name, and wherein either the horizontal axis name or the vertical axis name corresponds to the axis name of the at least one pairing in the graphing request;
generating a graph template of the graph display, in accordance with the received graphing request, such that the generated graph template specifies the data plot and the at least one data table; and
providing the graph template to a rendering engine of the graphing computer system, such that the rendering engine generates the graph display and produces the data plot such that the produced data plot includes plot points located relative to the horizontal axis of the data plot identified by the horizontal axis name and relative to the vertical axis of the data plot identified by the vertical axis name and textual representation of the data table aligned with the horizontal or vertical axis.

2. The computer-program product of claim 1, wherein the generated graph display includes at least one data table of the graph display, the generated data table comprising text data values from the dataset, and further comprising the data plot and the at least one data table, such that the text data values of the at least one data table are aligned with either the horizontal axis or the vertical axis of the data plot.

3. The computer-program product of claim 1, wherein the graphing request specifies more than one data table and, for each specified data table of the graph display, the graphing request includes the horizontal axis name or the vertical axis name with which the data table will be aligned and includes a table column name that identifies an additional subset of the dataset from which the text data values are obtained, such that the text data values are placed in the data table and correspond to index values on the axis, with which the data table values are aligned.

4. The computer-program product of claim 1, wherein the at least one data table comprises a lattice table that includes multiple data rows or columns or both.

5. The computer-program product of claim 1, wherein the graphing request includes a plurality of axis name and table column name pairs.

6. The computer-program product of claim 1, wherein the graphing request includes both a horizontal axis name and a vertical axis name.

7. The computer-program product of claim 1, wherein the data plot includes a secondary horizontal axis opposite the named horizontal axis.

8. The computer-program product of claim 7, wherein the graphing request specifies a data table aligned with the secondary horizontal axis.

9. The computer-program product of claim 1, wherein the data plot includes a secondary vertical axis opposite the named vertical axis.

10. The computer-program product of claim 9, wherein the graphing request specifies a data table aligned with the secondary vertical axis.

11. The computer-program product of claim 1, wherein generating the graph display comprises computing the configuration of the data table such that rows and columns of the data table are arranged in the graph display according to placement specified in the graphing request.

12. The computer-program product of claim 11, wherein the graph display includes multiple data tables arranged in alignment with an axis of the data plot.

13. The computer-program product of claim 12, wherein the graphing request includes preference weights and generating the graph template comprises arranging the rows and columns of the data table according to the preference weights.

14. The computer-program product of claim 1, wherein the graphing request includes text options that specify text operations on the text data values of the data table.

15. The computer-program product of claim 14, wherein the specified text operations affect a type font color of the text data values.

16. The computer-program product of claim 14, wherein the specified text operations affect a type size of the text data values.

17. The computer-program product of claim 14, wherein the specified text operations affect a type alignment of the text data values.

18. The computer-program product of claim 1, wherein attributes for the text data values can be received from a Discrete Attributes Map of the graphing computer system.

19. The computer-program product of claim 1, wherein the graphing request specifies one or more statistical processing options that are applied to the text data values.

20. A graphing computer system, the graphing computer system comprising:
a processor; and
a non-transitory computer-readable storage medium that includes instructions that are configured to be executed by the processor such that, when executed, the instructions cause the graphing computer system to perform operations including:
receiving a graphing request to generate a graph display, wherein the graphing request specifies at least one pairing of an axis name and a table column name, wherein the generated graph display includes a data plot and at least one data table, and the data plot of the generated graph display includes plot points located relative to a horizontal axis of the data plot identified by a horizontal axis name and located relative to a vertical axis of the data plot identified by a vertical axis name, and wherein either the horizontal axis name or the vertical axis name corresponds to the axis name of the at least one pairing in the graphing request;
generating a graph template of the graph display, in accordance with the received graphing request, such that the generated graph template specifies the data plot and the at least one data table; and
providing the graph template to a rendering engine of the graphing computer system, such that the rendering engine generates the graph display and produces the data plot such that the produced data plot includes plot points located relative to the horizontal axis of the data plot identified by the horizontal axis name and relative to the vertical axis of the data plot identified by the vertical axis name and textual representation of the data table aligned with the horizontal or vertical axis.

21. The graphing computer system of claim 20, wherein the generated graph display includes at least one data table of the graph display, the generated data table comprising text data values from the dataset, and further comprising the data plot and the at least one data table, such that the text data values of the at least one data table are aligned with either the horizontal axis or the vertical axis of the data plot.

22. The graphing computer system of claim 20, wherein the graphing request specifies more than one data table and, for each specified data table of the graph display, the graphing request includes the horizontal axis name or the vertical axis name with which the data table will be aligned and includes a table column name that identifies an additional subset of the dataset from which the text data values are obtained, such that the text data values are placed in the data table and correspond to plot points of the data plot, with which the data table values are aligned.

23. The graphing computer system of claim 20, wherein the at least one data table comprises a lattice table that includes multiple data rows or columns or both.

24. The graphing computer system of claim 20, wherein the graphing request includes a plurality of axis name and table column name pairs.

25. The graphing computer system of claim 20, wherein the graphing request includes both a horizontal axis name and a vertical axis name.

26. The graphing computer system of claim 20, wherein the data plot includes a secondary horizontal axis opposite the named horizontal axis.

27. The graphing computer system of claim 26, wherein the graphing request specifies a data table aligned with the secondary horizontal axis.

28. The graphing computer system of claim 20, wherein the data plot includes a secondary vertical axis opposite the named vertical axis.

29. The graphing computer system of claim 28, wherein the graphing request specifies a data table aligned with the secondary vertical axis.

30. The graphing computer system of claim 20, wherein the instructions further cause the processor of the graphing computer system to generate the graph display by computing the configuration of the data table such that rows and columns of the data table are arranged in the graph display according to placement specified in the graphing request.

31. The graphing computer system of claim 30, wherein the graph display includes multiple data tables arranged in alignment with an axis of the data plot.

32. The graphing computer system of claim 31, wherein the graphing request includes preference weights and generating the graph template comprises arranging the rows and columns of the data table according to the preference weights.

33. The graphing computer system of claim 20, wherein the graphing request includes text options that specify text operations on the text data values of the data table.

34. The graphing computer system of claim 33, wherein the specified text operations affect a type font color of the text data values.

35. The graphing computer system of claim 33, wherein the specified text operations affect a type size of the text data values.

36. The graphing computer system of claim 33, wherein the specified text operations affect a type alignment of the text data values.

37. The graphing computer system of claim 20, wherein attributes for the text data values can be received from a Discrete Attributes Map of the graphing computer system.

38. The graphing computer system of claim 20, wherein the graphing request specifies one or more statistical processing options that are applied to the text data values.

39. A method of operating a graphing computer system to generate a graph display based on a dataset, the method comprising:
receiving a graphing request to generate a graph display, wherein the graphing request specifies at least one pairing of an axis name and a table column name, wherein the generated graph display includes a data plot and at least one data table, and the data plot of the generated graph display includes plot points located relative to a horizontal axis of the data plot identified by a horizontal axis name and located relative to a vertical axis of the data plot identified by a vertical axis name, and wherein either the horizontal axis name or the vertical axis name corresponds to the axis name of the at least one pairing in the graphing request and textual representation of the data table aligned with the horizontal or vertical axis;
generating a graph template of the graph display, in accordance with the received graphing request, such that the generated graph template specifies the data plot and the at least one data table; and
providing the graph template to a rendering engine of the graphing computer system, such that the rendering engine generates the graph display and produces the data plot such that the produced data plot includes plot points located relative to the horizontal axis of the data plot identified by the horizontal axis name and relative to the vertical axis of the data plot identified by the vertical axis name.

40. The method of claim 39, wherein the generated graph display includes at least one data table of the graph display, the generated data table comprising text data values from the dataset, and further comprising the data plot and the at least one data table, such that the text data values of the at least one data table are aligned with either the horizontal axis or the vertical axis of the data plot.

41. The method of claim 39, wherein the graphing request specifies more than one data table and, for each specified data table of the graph display, the graphing request includes the horizontal axis name or the vertical axis name with which the data table will be aligned and includes a table column name that identifies an additional subset of the dataset from which the text data values are obtained, such that the text data values are placed in the data table and correspond to plot points of the data plot, with which the data table values are aligned.

42. The method of claim 39, wherein the at least one data table comprises a lattice table that includes multiple data rows or columns or both.

43. The method of claim 39, wherein the graphing request includes a plurality of axis name and table column name pairs.

44. The method of claim 39, wherein the graphing request includes both a horizontal axis name and a vertical axis name.

45. The method of claim 39, wherein the data plot includes a secondary horizontal axis opposite the named horizontal axis.

46. The method of claim 45, wherein the graphing request specifies a data table aligned with the secondary horizontal axis.

47. The method of claim 39, wherein the data plot includes a secondary vertical axis opposite the named vertical axis.

48. The method of claim 47, wherein the graphing request specifies a data table aligned with the secondary vertical axis.

49. The method of claim 39, wherein generating the graph display comprises computing the configuration of the data table such that rows and columns of the data table are arranged in the graph display according to placement specified in the graphing request.

50. The method of claim 49, wherein the graph display includes multiple data tables arranged in alignment with an axis of the data plot.

51. The method of claim 50, wherein the graphing request includes preference weights and generating the graph template comprises arranging the rows and columns of the data table according to the preference weights.

52. The method of claim 39, wherein the graphing request includes text options that specify text operations on the text data values of the data table.

53. The method of claim 52, wherein the specified text operations affect a type font color of the text data values.

54. The method of claim 52, wherein the specified text operations affect a type size of the text data values.

55. The method of claim 52, wherein the specified text operations affect a type alignment of the text data values.

56. The method of claim 39, wherein attributes for the text data values can be received from a Discrete Attributes Map of the graphing computer system.

57. The method of claim 39, wherein the graphing request specifies one or more statistical processing options that are applied to the text data values.
